(19) United States
(12) Patent Application Publication
(10) Pub. No.: US 2022/0379298 A1
(43) Pub. Date: Dec. 1, 2022

(54) DEVICES AND METHOD FOR MULTI-WELL PLATE LIQUID DISTRIBUTION

(71) Applicant: Meso Scale Technologies, LLC., Rockville, MD (US)

(72) Inventor: Manish KOCHAR, Rockville, MD (US)

(21) Appl. No.: 17/826,595

(22) Filed: May 27, 2022

Related U.S. Application Data
(60) Provisional application No. 63/194,518, filed on May 28, 2021.

(51) Int. Cl. B01L 3/00

(52) U.S. Cl. CPC B01L 3/508; B01L 2300/0829; B01L 2200/025; B01L 2300/0851

(57) ABSTRACT

Devices and methods for multi-well plate liquid distribution are provided. Devices herein provide a plurality of dispensing stations configured to receive and dispense or disburse liquid to the wells of a multi-well plate. The dispensing stations include dispensing surfaces configured to receive liquid droplets dispensed by manual or automatic pipettes. The dispensing surfaces are configured to retain received liquids until force is applied and distribution to the wells of the multi-well plate occurs. Devices and methods provided herein increase the consistency of laboratory results in procedures requiring liquid distribution.

### FIELD OF THE INVENTION

The present invention is directed to devices and methods for distributing liquids to sample wells of a multi-well plates.

### BACKGROUND

A liquid dispenser, such as a pipette may be used to transport a specified amount of liquid from a reservoir that stores liquid to a target well of a multi-well plate. Use of a liquid dispenser may be automated using an automated liquid dispenser system capable of moving the liquid dispenser and a piston of the liquid dispenser. For example, an automated dispenser system may control the liquid dispenser to draw a specified amount of liquid from a liquid reservoir and to dispense the specified amount of liquid at a target location, with no or little human intervention. Liquid dispensers may also be operated manually to dispense specified amounts of liquid to a multi-well plate.

### SUMMARY

In an embodiment, a device configured to overlay a multi-well plate is provided. The device comprises a substrate panel having a top surface and a bottom surface and including an array of openings; an array of dispensing stations, each dispensing station corresponding to one of the array of openings and including: at least one support rib extending from the substrate panel, and a dispensing surface supported by the at least one support rib.

In another embodiment, a device configured to overlay a multi-well plate is provided. The device comprises a substrate panel having a top surface and a bottom surface and including an array of openings; an array of dispensing stations, each dispensing station corresponding to one of the array of openings and including: at least one dispensing surface extending from the substrate panel, the dispensing surface including a continuous circumferential surface with an opening disposed therein.

In another embodiment, a method of dispensing liquid to a multi-well plate via a pipette is provided. The method includes dispensing predetermined amounts of liquids onto each dispensing surface of an array of dispensing stations of a multi-well plate overlay device; applying vibration to the multi-well plate; and causing distribution of the predetermined amounts of liquids from each dispensing surface to respective wells of the multi-well plate.

In another embodiment, a method of dispensing liquid to a multi-well plate via a pipette is provided. The method includes dispensing predetermined amounts of liquids onto each dispensing surface of an array of dispensing stations of a multi-well plate overlay device; applying pressure to the multi-well plate via a pressure manifold; and causing distribution of the predetermined amounts of liquids from each dispensing surface to respective wells of the multi-well plate.

In another embodiment, a device configured to overlay a multi-well plate is provided. The device includes a substrate panel having a top surface and a bottom surface and including an array of openings; an array of dispensing stations, each dispensing station corresponding to one of the array of openings and including: at least one tapered wall extending from the substrate panel, the at least one tapered wall defining a continuous circumferential surface with a pipette opening disposed therein.

In another embodiment, a method of dispensing liquid to a multi-well plate via a pipette is provided. The method includes dispensing predetermined amounts of liquids onto each dispensing surface of an array of dispensing stations of a multi-well plate overlay device; applying mechanical force to the multi-well plate; and causing, in response to the mechanical force, distribution of the predetermined amounts of liquids from each dispensing surface to respective wells of the multi-well plate.

In another embodiment, a method of dispensing liquid to a multi-well plate via a pipette is provided. The method includes dispensing predetermined amounts of liquids onto each dispensing surface of an array of dispensing stations of a multi-well plate overlay device; applying pressure to the multi-well plate via a pressure manifold; and causing, in response to the pressure, distribution of the predetermined amounts of liquids from each dispensing surface to respective wells of the multi-well plate.

In another embodiment, a method of dispensing liquid to a multi-well plate via a pipette is provided. The method includes dispensing predetermined amounts of liquids onto each dispensing surface of an array of dispensing stations of a multi-well plate overlay device, the dispensing surfaces being arranged at a substantially non-parallel angle with respect to a bottom surface of the multi-well plate overlay device; causing distribution of the predetermined amounts of liquids from each dispensing surface to respective wells of the multi-well plate.

In another embodiment, a device configured to overlay a multi-well plate is provided. The device includes a substrate panel having a top surface and a bottom surface and including an array of openings; an array of dispensing stations, each dispensing station corresponding to one of the array of openings and including: at least one tapered wall extending from the substrate panel, the at least one tapered wall defining a partially circumferential surface with a pipette opening disposed therein.

### BRIEF DESCRIPTION OF THE DRAWINGS

The foregoing and other features, objects and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1A illustrates a multi-well plate liquid distribution device in plan view consistent with embodiments hereof.

FIG. 1B illustrates a multi-well plate liquid distribution device in profile view consistent with embodiments hereof.

FIG. 1C illustrates a liquid dispensing station consistent with embodiments hereof.

FIGS. 2A-2B illustrate a multi-well plate liquid distribution device consistent with embodiments hereof.

FIGS. 3A-3C illustrates operation of a multi-well plate liquid distribution device in profile view consistent with embodiments hereof.

FIGS. 4A-4C illustrates operation of a multi-well plate liquid distribution device in profile view consistent with embodiments hereof.

FIG. 5 illustrates a liquid dispensing station consistent with embodiments hereof.

FIGS. 6A-6D illustrates operation of a multi-well plate liquid distribution device in profile view consistent with embodiments hereof.

FIG. 7 illustrates liquid dispensing stations consistent with embodiments hereof.

FIG. 8A-8D illustrates operation of a multi-well plate liquid distribution device in profile view consistent with embodiments hereof.

FIGS. 9A-9C illustrates a multi-well plate liquid distribution device in profile view consistent with embodiments hereof.

FIG. 10 illustrate a multi-well plate liquid distribution device consistent with embodiments hereof.

FIGS. 11A-11C illustrate a multi-well plate liquid distribution device consistent with embodiments hereof.

FIG. 12 is a flow chart illustrating a method of dispensing and distributing liquids to a micro-well assay plate consistent with embodiments hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Many modern laboratory techniques rely on liquid distribution methods. The results of such techniques may be improved through the use of on fast, accurate, and precise liquid distribution methods. Some liquid distribution techniques include the use of manual, automatic, and/or hybrid pipetting systems. Improvements in laboratory results may be increased by improving the speed, accuracy, and precision of liquid distribution via pipettes, as described with respect to embodiments provided herein. Embodiments described herein may address drawbacks in known pipetting methods and techniques.

In some known methods of pipetting liquids into microplates, one, eight, twelve, ninety-six (or other number) of pipettes and pipettors are used to dispense liquids to a multi-well plate. The multiple pipettors can dispense to a corresponding number of wells simultaneously before moving to the next set of wells. For example, an eight pipettor design can dispense liquid to eight wells at a time before moving to another set of eight wells. This arrangement can cause significant timing variances in application of samples and reagents across the plate. This timing variation may affect assay performance specifications such as % CVs and uniformity. Such timing variations can become even greater in manual pipetting scenarios.

In some known automated systems, liquid may be dispensed perpendicularly and directly onto the bottom of microplate wells. Certain assays, such as cellular assays, may be susceptible to shear forces introduced during dispensing of reagents onto the surface of the well bottom. These forces can disturb or wash reaction product off the surface of the plate and affect assay performance. Manual pipetting scenarios may suffer from similar issues if the operator does not take care in dispensing the liquid.

In some known systems, cross-contamination between sample wells is possible if pipettor tips are reused across multiple wells. As a best practice, to obtain the best precision and accuracy of the dispensed volume, liquid is dispensed from a pipettor directly to a surface and the pipettor tips are kept in contact with the surface of the liquid as it is dispensed. This can cause the inadvertent transfer of contents from one well to the next. The amount of material transferred has been found to be significant for sensitive assay methods that have an amplification step. Such inadvertent contact may be eliminated by changes of pipetting tips between dispensing actions, but this has the drawbacks of expense and time taken to exchange tips (resulting in longer time periods between dispensing actions).

Each of the above-described drawbacks can decrease the consistency and increase the variation in results obtained from multiple types of procedures. Embodiments described herein relate to devices and methods for improving liquid distribution into microplates (i.e., multi-well plates), resulting in improved consistency and decreased variation in results across multiple types of laboratory procedures. Embodiments described herein provide methods for precision pipetting in automated, manual, and hybrid systems. Improvements may include synchronized, simultaneous distribution of liquid, increased dispensing accuracy, prevention of disturbances to assay product contained in the wells of the plate, and prevention of contact of pipette tips with any of the surfaces of the microplate. Embodiments of the present disclosure address one or more of the above-discussed drawbacks with conventional pipetting techniques.

Several embodiments discussed herein are described with respect to the specific use of pipettes, multi-well plates such as a multi-well assay plates, and assay environments. Such descriptions are provided for context and do not limit the scope of the liquid distribution devices, methods, and techniques described herein. The liquid distribution devices, methods, and techniques described herein are applicable to any technique or application requiring precise and accurate liquid distribution to multiple locations. For example, embodiments described herein may be applied to cell cultures as well as any other scientific, analytical, and/or laboratory processes requiring the mixing of small volumes of liquids. In other examples, embodiments described herein may be applied to reaction tubes, e.g., Streptavidin-Coated PCR 8-Strip Tubes and test cartridges, such as Proteinsimple® Simple Plex Assays Human, Mouse, and Rat analyte cartridges. Liquid dispensers compatible with embodiments described herein are not limited to pipettes, and may include syringes, pumps, bulb-type liquid dispensers, and others.

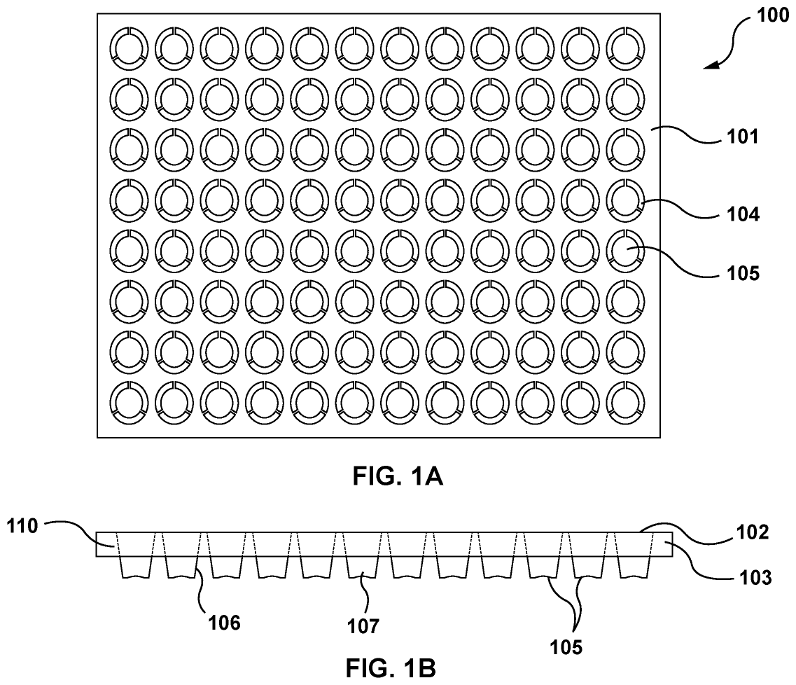

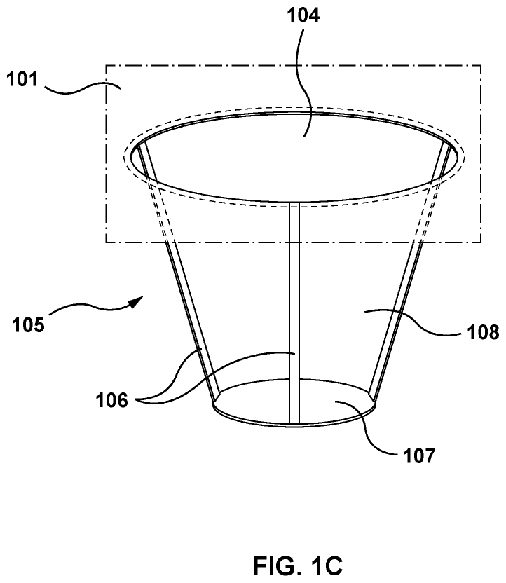

FIG. 1A illustrates a multi-well plate liquid distribution device 100 (also referred to herein as a multi-well plate overlay device) in plan view consistent with embodiments hereof. FIG. 1B illustrates a multi-well plate liquid distribution device in profile view consistent with embodiments hereof. FIG. 1C illustrates a dispensing station 105 of a multi-well plate liquid distribution device in a detailed view. The multi-well plate liquid distribution device 100 is configured to overlay a multi-well plate (not shown in FIGS. 1A-1C). The multi-well plate liquid distribution device 100 includes a substrate panel 101 having a top surface 102 and a bottom surface 103 and an array of openings 104. In embodiments, the substrate panel 101 may further include a rim 110 extending around the perimeter of the substrate panel 101 and configured to interface with the outer perimeter of a multi-well plate. The array of openings 104 corresponds to an array of dispensing stations 105, wherein each opening 104 corresponds to a dispensing station 105.

The dispensing stations 105 are shown in profile in FIGS. 1B and 1n closer detail in FIG. 1C. Each of the dispensing stations 105 includes at least one support rib 106 extending from the substrate panel 101 to a dispensing surface 107 supported (e.g., suspended) by the at least one support rib 106. The dispensing station 105 of FIG. 1C includes side portions 108 that are substantially open. Because the side portions 108 of the dispensing station 105 are substantially open, side portions of the dispensing surface 107 may also be substantially open. The support ribs 106 connect to and support the dispensing surface 107. The support ribs 106 are relatively thin compared to the length (e.g., circumference) of the outer perimeter of the dispensing surface 107. Thus, the shape defined by the support ribs 106, dispensing surface 107, and substrate panel 101 (as illustrated in FIG. 1C, a conical frustum) has side portions 108 that are substantially open, unobstructed, or unimpeded by the surfaces illustrated in FIG. 1C. The substantially open side portions 108 are sized and configured to permit liquid or liquid droplets to be released from, flow away from, or be distributed from the dispensing surface 107 when mechanical force (such as vibration, shaking, or tipping) is applied to the multi-well plate liquid distribution device 100, as discussed in greater detail below.

In embodiments, the substantially open side portions 108 may be more than 75% open or unimpeded, more than 80% open or unimpeded, more than 90% open or unimpeded, more than 95% open or unimpeded, more than 98% open or unimpeded, or more than 99% open or unimpeded, although other percentages, greater or less, than those listed here are also contemplated.

In embodiments, the substantially open side portions 108 may extend only a partial distance above the dispensing surface 107. For example, the support ribs 106 may thicken or widen closer to the substrate panel 101. In another example, the support ribs 106 may be partially or completely connected to one another by a perimeter wall on the side of the substrate panel 101. In such an embodiment, the substantially open side portions 108 may leave open only a small percentage of the total wall area of the shape defined by the support ribs 106, dispensing surface 107, and substrate panel 101, while leaving open a relatively larger percentage of a perimeter section of the wall area adjacent to the dispensing surface 107. For example, if the support ribs 106, dispensing surface 107, and substrate panel 101 define a shape resembling a conical frustum, or define an outline of such a shape, the substantially open side portions 108 in such an example may leave open only a small percentage of a total area of an overall side surface of the conical frustum, but may leave open a relatively larger percentage of a portion of the side surface that is adjacent to the dispensing surface 107, wherein the portion adjacent to the dispensing surface may form a perimeter section of the dispensing surface 107. In such an embodiment, the substantially open side portions 108 may leave open or unimpeded more than 75% of a perimeter section of the dispensing surface 107, more than 80% of a perimeter section of the dispensing surface, more than 90% of a perimeter section of the dispensing surface, more than 95% of a perimeter section of the dispensing surface, more than 98% of a perimeter section of the dispensing surface, or more than 99% of a perimeter section of the dispensing surface although other percentages, greater or less, than those listed here are also contemplated.

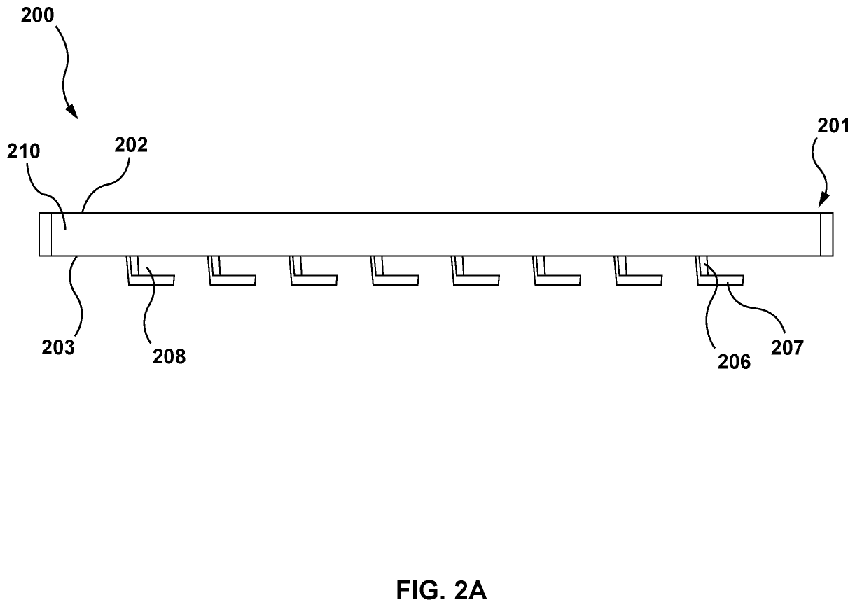

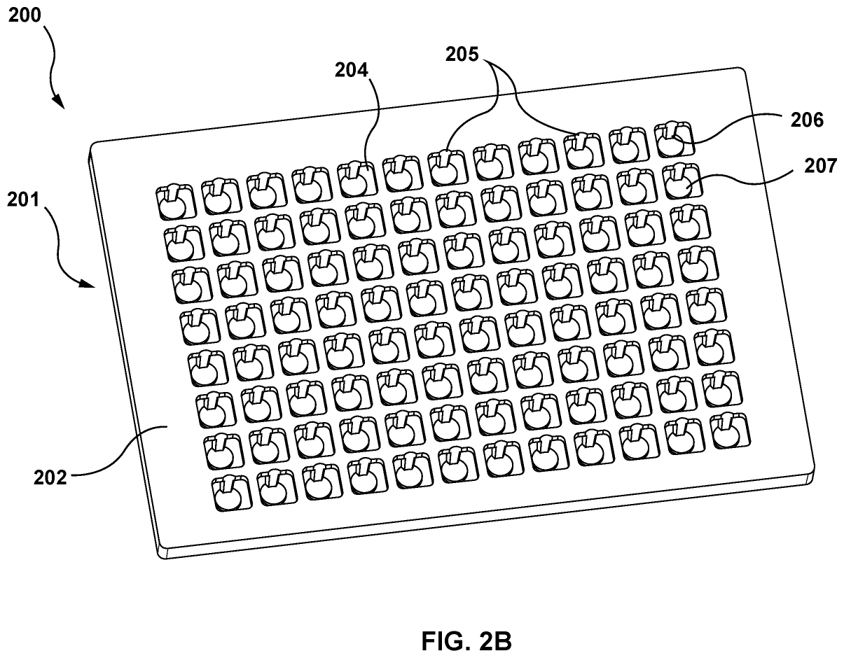

FIGS. 2A-2B illustrate a multi-well plate liquid distribution device 200 (also referred to herein as a multi-well plate overlay device) consistent with embodiments hereof. The multi-well plate liquid distribution device 200 is configured to overlay a multi-well plate (not shown in FIGS. 2A-2B). The multi-well plate liquid distribution device 200 optionally includes any of the features described above with respect to the multi-well liquid distribution device 100. The multi-well liquid distribution device includes a substrate panel 201 having a top surface 202 and a bottom surface 203 and an array of openings 204. In embodiments, the substrate panel 201 may further include a rim 210 extending around the perimeter of the substrate panel 201 and configured to interface with the outer perimeter of a multi-well plate. The array of openings 204 corresponds to an array of dispensing stations 205, wherein each opening 204 corresponds to a dispensing station 205.

The dispensing stations 205 are shown in profile in FIG. 2B. Each of the dispensing stations 205 includes a support rib 206 extending from the substrate panel 201 to a dispensing surface 207 supported (e.g., suspended) by the support rib 206. The dispensing station 205 includes side portions 208 that are substantially open, as described above with respect to the dispensing station 105. Because the side portions 208 of the dispensing station 205 are substantially open, side portions of the dispensing surface 207 may also be substantially open. The support rib 206 connects to and supports the dispensing surface 207. The support ribs 206 is relatively thin compared to the length (e.g., circumference) of the outer perimeter of the dispensing surface 207. Thus, the shape defined by the support ribs 206, dispensing surface 207, and substrate panel 201 (as illustrated in FIG. 2B, a conical frustum) has side portions 208 that are substantially open, unobstructed, or unimpeded by any surfaces. The substantially open side portions 208 are sized and configured to permit liquid or liquid droplets to be released from, flow away from, or be distributed from the dispensing surface 207 when mechanical force (such as vibration, shaking, or tipping) is applied to the multi-well plate liquid distribution device 200, as discussed in greater detail below.

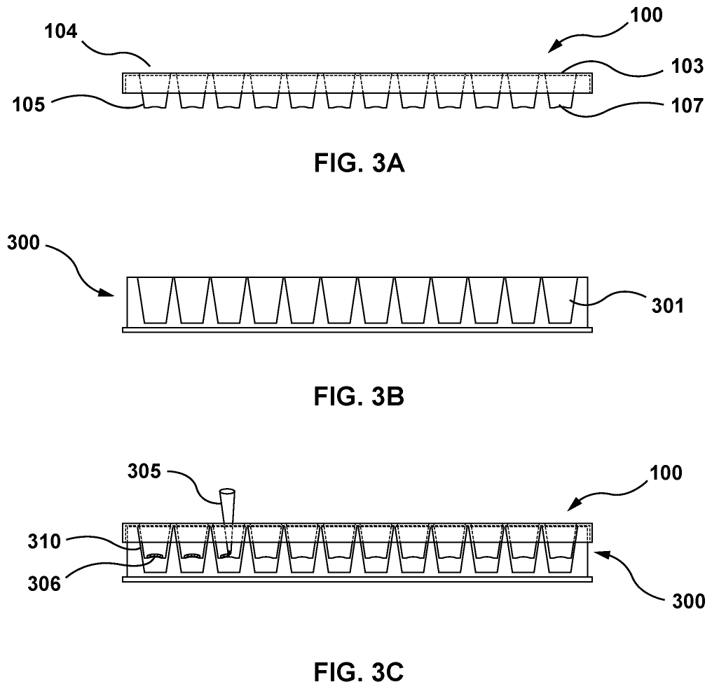

FIGS. 3A-3C illustrate the multi-well plate liquid distribution device 100 in use with a multi-well plate. The process illustrated in FIGS. 3A-3C is equally applicable to the multi-well plate liquid distribution device 200 and/or to any variations of the multi-well plate liquid distribution devices 100, 200, described herein. The multi-well plate liquid distribution device 100 is overlaid on a multi-well plate 300 containing an array of sample wells 301. The multi-well plate 300 may be a multi-well assay plate or any other plate containing multiple liquid receptacle wells. In embodiments, the array of openings 104 and dispensing stations 105 are configured or arranged so as to correspond to the array of wells 301 in the multi-well plate 300. The array of dispensing stations 105 are configured to correspond to at least a portion of the wells 301, and more specifically may correspond to all of wells 301 in the multi-well plate 300. In some arrangements, the multi-well plate liquid distribution device 100 is configured to overlay only a portion of the wells 301 and thus may leave a portion of the wells 301 open. For instance, if a total number of wells 301 in the multi-well plate is greater than a total number of dispensing stations 105 or a total number of openings 104 of the liquid distribution device 100, then the multi-well plate liquid distribution device 100 may overlay some of the wells of the multi-well plate and may leave remaining wells open. When overlaid on the multi-well plate, the dispensing stations 105 may extend into the wells 301.

In further embodiments, the multi-well plate liquid distribution device 100 may be configured such that the dispensing surfaces 107 of the dispensing stations 105 are suspended directly above, but not inside of, the wells 301. In such an embodiment, each dispensing surface 107 aligns with a respective well 301 but is suspended above the well 301, rather than inside of the well 301. In further embodiments, the multi-well plate liquid distribution device 100 may be suspended above the multi-well plate 300, e.g., via a support structure, without contacting the multi-well plate 300.

As discussed above, each dispensing station 105 includes a dispensing surface 107. The support ribs 106 support (e.g., suspend) the dispensing surfaces 107 of the respective dispensing stations 105 above the bottom of the wells 301. When the bottom surface 103 of the substrate panel 101 rests on or otherwise contacts at least a portion of the top surface of the multi-well plate 300, as shown in FIG. 3C, the dispensing surfaces 107 are suspended above the bottoms of the wells 301 by the support ribs 106. In embodiments, the dispensing surfaces 107 may be substantially parallel to the bottom surface 103 of the substrate panel 101. For example, each of the dispensing surfaces 107 may have a perimeter or edge which defines a plane that is substantially parallel to the bottom surface 103 of the substrate panel 101. As used herein, substantially parallel means within 1%, within 2%, and/or within 5% of parallel.

The dispensing surfaces 107 are, e.g., sized and adapted such that, when suspended above the bottom of the wells 301 of a multi-well plate 300, a gap 310 exists between the edges of the dispensing surfaces 107 and the respective walls of the wells 301. The gap 310 is sized to be large enough to permit liquid to pass through without being retained by surface tension.

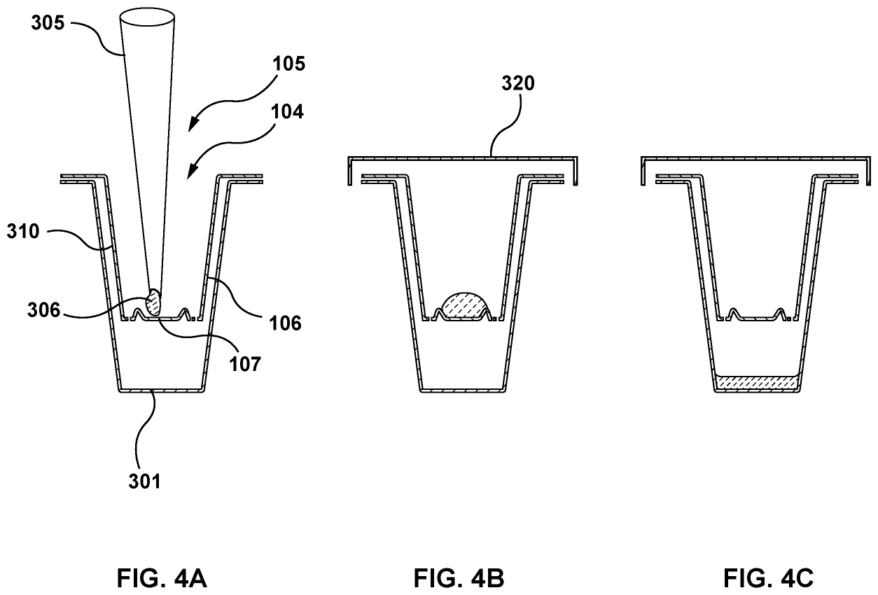

The dispensing surfaces 107 are configured to receive a volume of liquid 306, e.g., as liquid droplets, dispensed from a pipette or pipettor 305. The volume of liquid 306 may include, for example, samples, reagents, and other liquids in use in an assay. The dispensing surface 107 is configured to retain the volume of liquid 306 until force is applied to the liquid volume 306, for example, applied through mechanical motion of the dispensing surfaces 107, pressure to the liquid volume 306, or other means. The dispensing surface 107 may include various features to retain the liquid droplet until the force is applied. For example, in embodiments, the dispensing surface 107 may comprise a material or have a coating that is hydrophobic, causing any liquid placed thereon to bead up due to surface tension. In further embodiments, the dispensing surface 107 may be textured with a surface texture that promotes beading of liquid. The surface texture may cause the dispensing surface 107 to retain the volume of liquid 306 (e.g., via surface tension), and to prevent the volume of liquid 306 from exiting the dispensing surface 107 via side portions 108 thereof. In still further embodiments, the dispensing surface 107 may include a raised rim or lip that (e.g., as shown in FIG. 4A) promotes liquid beading. In embodiments, one or more of these features may be selected to promote liquid beading and retention. In embodiments, the one or more features selected to promote liquid retention may be selected according to a surface tension of a liquid to be deposited. In embodiments, the dispensing surface 107 may be shaped to enhance liquid distribution when force is applied. For example, as shown in FIG. 3A, the dispensing surface 107 may be convex (e.g., may curve upward from a perimeter or edge of the dispensing surface 107 toward a center thereof), which may promote complete liquid distribution when force is applied and the surface tension of the liquid droplet placed thereon is overcome. In further embodiments, the surface may be concave or may be flat or substantially flat. Other surface profiles, such as trapezoidal may also be used to promote complete liquid distribution.

FIGS. 4A-4C illustrate a process of dispensing and distributing liquid via a liquid distribution device consistent with embodiments hereof. The multi-well plate liquid distribution device 100 (only a portion of which is illustrated FIGS. 4A-4C) is placed atop the multi-well plate 300, with the dispensing stations 105 aligning with the wells 301, e.g., as shown in FIG. 3C. A pipette 305, manual or automatic, is used to dispense a volume of liquid 306 to the dispensing surface 107. The pipette 305 may stay in contact with the volume of liquid 306 during the dispensing action. One or more pipettes 305 are used to dispense volume of liquid 306 to each of the dispensing surfaces 107 that require liquids. Because the dispensing surfaces 107 are clean, the pipettes 305 may be reused across as many wells 301 as necessary without concern for cross contamination.

After all liquid has been distributed to the dispensing surfaces 107, a plate lid 320 may optionally be placed atop the multi-well plate liquid distribution device 100 and the multi-well plate 300. This assembly is then placed atop a device (if it is not already), such as a shaker, configured for applying force to the multi-well plate liquid distribution device 100 in the form of mechanical motion.

As discussed above, force applied to the multi-well plate liquid distribution device 100 may include mechanical motion, pressure, or other means. Mechanical motion may include, for example, vibration, rotational or orbital motion of the multi-well plate liquid distribution device 100 and the multi-well plate 300. Mechanical motion may further include tipping of the multi-well plate liquid distribution device 100 and the multi-well plate 300 to permit gravitational force to distribute the liquid droplets into the wells 301. Mechanical motion may also be applied manually and may include tipping the multi-well plate 300 or multi-well plate liquid distribution device 100, and/or tapping a side of the multi-well plate 300 or multi-well plate liquid distribution device 100, and/or agitating the multi-well plate 300 or multi-well plate liquid distribution device 100 in any other fashion.

The shaker or other mechanical device is energized for a brief period of time (e.g., 30-60 seconds) to allow the liquid from the receiving surfaces to be dispensed or disbursed to the wells 301 of the assay plate. Optimal shaking parameters may be selected according to the surface tension of the liquid, the shape of the dispensing surfaces 107, and other factors. The applied mechanical motion causes any surface tension in the volume of liquid 306 to release and the volume of liquid 306 to release from the dispensing surfaces 107. The volume of liquid 306 are thus distributed to the wells 301. Continued mechanical motion may cause any liquid landing on the walls of the wells 301 to run down the walls into the bottoms of the wells 301.

Because the mechanical motion is applied to all wells 301 at the same time, each volume of liquid 306 enters the bottom of each well 301 at substantially the same time, providing a synchronized distribution of liquid into the selected wells 301 of the multi-well plate 300. Further, because the droplets are not pushed or sprayed directly into the bottoms of the wells 301, shear forces are reduced and the contents of the wells 301 are less likely to be disturbed during distribution.

When applying the methods and devices described herein to assay-based applications, some of the following steps may be completed after distribution of the liquid from the dispensing surfaces 107. Upon completion of distribution, multi-well plate liquid distribution device 100 may be removed and optionally replaced with the plate seal or plate lid 320. The multi-well plate 300 may then be incubated with the sample/reagent in accordance with the prescribed conditions for the assay.

In embodiments, shaking steps in an incubation process may take the place of the mechanical motion described above. If the shaking parameters used for incubation meet or exceed the requirements for effective distribution of the sample/reagents, then the dedicated distribution step may be eliminated. However, depending on the reagent and volume being dispensed, it may be necessary to hold the plate stationary for a brief period to allow any liquids deposited on the assay plate's well walls to move to the bottom. In such embodiments, incubation may occur with the multi-well plate liquid distribution device 100 still in place between the multi-well plate 300 and the plate lid 320.

Upon completion of the incubation step, the multi-well plate liquid distribution device 100 is removed to allow the multi-well plate 300 to be washed prior to the addition of the next reagent. The multi-well plate liquid distribution device 100 is removed and a new multi-well plate liquid distribution device 100 may be used for each reagent addition step. Alternately, with some automated systems, the multi-well plate liquid distribution device 100 may be held and reused with the same multi-well plate 300 for subsequent assay steps.

Accordingly, the multi-well plate liquid distribution device 100 addresses at least three drawbacks of some liquid distribution pipetting techniques. First, the multi-well plate liquid distribution device 100 eliminates timing variations due to sequential addition of sample and/or reagents across a plate. When using the multi-well plate liquid distribution device 100, sample and/or reagents are added sequentially to the multi-well plate liquid distribution device 100, not the multi-well plate 300. Samples/Reagents are then simultaneously dispensed or disbursed to the corresponding wells 301 as described above. Simultaneous or synchronized distribution may provide significant benefits in assay results, as each reaction in each sample well 301 will begin at approximately the same time, rather than having various start times depending on speed of the pipetting process. Second, when using the multi-well plate liquid distribution device 100, reagents are disbursed to the side walls of the multi-well plate 300, not the plate bottom and therefore shear effects on assay performance are minimized. Third, when using the multi-well plate liquid distribution device 100, cross-contamination between wells 301 during sequential addition of reagents to multiple wells 301 using the same set of pipettor tips is eliminated. Reagents are added sequentially to the multi-well plate liquid distribution device 100 (e.g., to multiple dispensing surfaces 107 thereof), not the multi-well plate 300. The dispensing surfaces 107 of the multi-well plate liquid distribution device 100 never contact the contents of the multi-well plate 300. Thus, even with the re-use of pipette tips, there is no possibility of cross-contamination or carryover between wells 301.

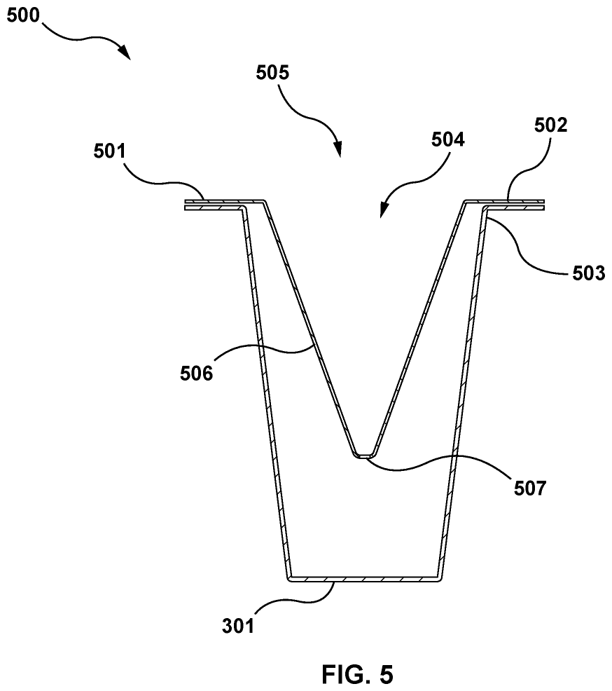

FIG. 5 illustrates a liquid dispensing station consistent with embodiments hereof. A multi-well liquid distribution device 500 (also referred to herein as a multi-well plate overlay device), only a portion of which is shown in FIG. 5, includes a liquid dispensing station 505 and a substrate panel 501, only a portion of which is shown in FIG. 5. The remainder of the multi-well liquid distribution device 500 may include an array of the liquid dispensing stations 505, similar to and optionally including any features of the multi-well liquid distribution device 100. The substrate panel 501 includes features and construction similar to those of the substrate panel 101. The substrate panel 501 has a top surface 502, a bottom surface 503, and an array of openings 504. In embodiments, the substrate panel 501 may further include a rim (not shown) extending around the perimeter of the substrate panel 501 and configured to interface with the outer perimeter of a multi-well plate. The array of openings 504 corresponds to an array of dispensing stations 505, wherein each opening 504 corresponds to a dispensing station 505.

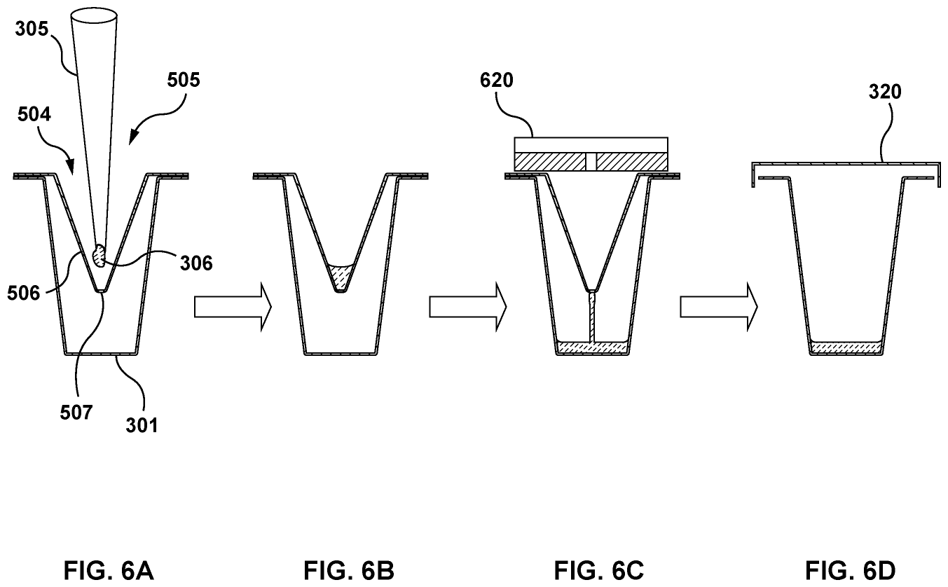

The dispensing stations 505 include dispensing surfaces 506 extending from the substrate panel 501. The dispensing surfaces 506 each may include a continuous circumferential surface and have an opening or orifice disposed therein. The dispensing surfaces 506 define a cone shaped structure with a base at the substrate panel 501 and an apex. At the apex of the cone shaped structure is an orifice 507. The orifice 507 is sized and configured to be small enough to prevent passage of the liquids dispensed into the insert's wells absent application of force, e.g., as provided by pressure, to drive it into a well (e.g., microplate well). The orifice is configured to prevent liquid flow and retain liquid droplets when the pressure on the liquid is below a pressure threshold, e.g., via surface tension in the liquid. The orifice is further configured and sized to permit liquid flow and disbursal of the liquid droplets when the pressure on the liquid exceeds a pressure threshold. Accordingly, the size of the orifice 507 may be determined according to the properties, e.g., density, surface tension, viscosity, of liquids that are intended to be contained in the dispensing station 505 as well as ambient pressure. The opening 504 is large enough to receive the tip of a pipette or pipettor, and the dispensing surfaces 506 may receive a liquid droplet dispensed from the tip. The orifice is narrow enough so as to retain a liquid volume within the dispensing station 505 until and unless force is applied to the liquid volume. In embodiments, as discussed with respect to FIG. 6C, the force may be applied in the form of pressure. The circumferential surface of the dispensing surfaces 506 may be conical, as shown in FIG. 5, and/or may be any other tapering shape. The dispensing surfaces 506 may further describe rectangular, square, multi-sided, and/or any other tapering shape.

In further embodiments, the multi-well plate liquid distribution device 500 may be configured such that the dispensing surfaces 107 of the dispensing stations 505 are suspended directly above, but not inside of, the wells 301. In further embodiments, the multi-well plate liquid distribution device 500 may be suspended above the multi-well plate 300, e.g., via a support structure, without contacting the multi-well plate 300.

FIGS. 6A-6D illustrate a process of dispensing and distributing liquid via a liquid dispensing station consistent with embodiments hereof. The multi-well plate liquid distribution device 500 is placed atop (e.g., overlaid on) the multi-well plate 300, with the dispensing stations 505 aligning with the wells 301. A pipette 305, manual or automatic, is used to dispense a volume of liquid 306 to the dispensing surfaces 506. The pipette 305 may stay in contact with the volume of liquid 306 during the dispensing action. One or more pipettes 305 are used to dispense volume of liquid 306 to each of the dispensing stations 505 that require liquids. Because the dispensing surfaces 506 are clean, the pipettes 305 may be reused across as many wells 301 as necessary without concern for cross contamination.

After all liquid has been distributed to the dispensing stations 505, a pressure manifold 620 is placed atop the multi-well plate liquid distribution device 500 and the multi-well plate 300. Pressure is then applied to the dispensing stations 505 through the pressure manifold, for example, by a pump. Force is applied to the multi-well plate liquid distribution device 500 in the form of pressure sufficient to expel the volume of liquid 306 through the orifice 507 and into the bottoms of the wells 301. The pressure applied via the pressure manifold 620 may be controlled so as to expel the volume of liquid 306 slowly enough to prevent disturbances to the contents of the wells 301.

Because the pressure can be applied to all wells 301 at the same time, each volume of liquid 306 enters the bottom of each well 301 at substantially the same time, providing a synchronized distribution of liquid into the selected wells 301 of the multi-well plate 300.

In embodiments, the pressure manifold 620 may apply pressure to any number of dispensing stations 505 at one time. Accordingly, liquid distribution into the wells 301 may occur according to any timing pattern. For example, the wells 301 of the multi-well plate 300 may be divided into multiple groups and the pressure manifold 620 may apply pressure to each of the multiple groups with a particular timing pattern to add liquid to the wells 301 according to a specific protocol.

In embodiments, the pressure manifold 620 may be configured to provide pressure to all or a portion of the dispensing stations 505 simultaneously. The pressure manifold 620 may include, for example, multiple zones which may be pressurized to provide pressure to a subset of the dispensing stations 505. The pressure manifold 620 may also be configured such that it does not cover an entirety of the dispensing stations 505 and may be moved between different positions to apply pressure to subsets of the dispensing stations 505.

When applying the methods and devices described herein to assay-based applications, some of the following steps may be completed after distribution of the liquid from the orifices 507. Upon completion of distribution, the multi-well plate liquid distribution device 500 may be removed and optionally replaced with the plate seal or plate lid 320. The multi-well plate 300 may then be processed in the incubator with the sample/reagent in accordance with the prescribed conditions for the assay.

Accordingly, the multi-well plate liquid distribution device 500 addresses at least three drawbacks of some liquid distribution pipetting techniques. First, the multi-well plate liquid distribution device 500 eliminates timing variations due to sequential addition of sample and/or reagents across a plate. When using the multi-well plate liquid distribution device 500, sample and/or reagents are added sequentially to the multi-well plate liquid distribution device 500 (e.g., to multiple dispensing surfaces 506), not the multi-well plate 300. After the samples/reagents are added to the dispensing surfaces 506 of the device 500, the samples/reagents are then simultaneously disbursed to the corresponding wells 301 as described above. Second, when using the multi-well plate liquid distribution device 500, shear forces on the bottoms of the wells 301 are reduced or eliminated. Pressure control of the manifold 620 may be used to control the force of liquid droplets disbursed through the orifices 507, thereby preventing excessive shear forces at the bottoms of the wells 301. Third, when using the multi-well plate liquid distribution device 500, cross-contamination between wells 301 during sequential addition of reagents to multiple wells 301 using the same set of pipettor tips is eliminated. Reagents are added sequentially to the multi-well plate liquid distribution device 500, not the multi-well plate 300. The dispensing surfaces 506 of the multi-well plate liquid distribution device 500 never contact the contents of the multi-well plate 300. Thus, even with the re-use of pipette tips, there is no possibility of cross-contamination or carryover between wells 301.

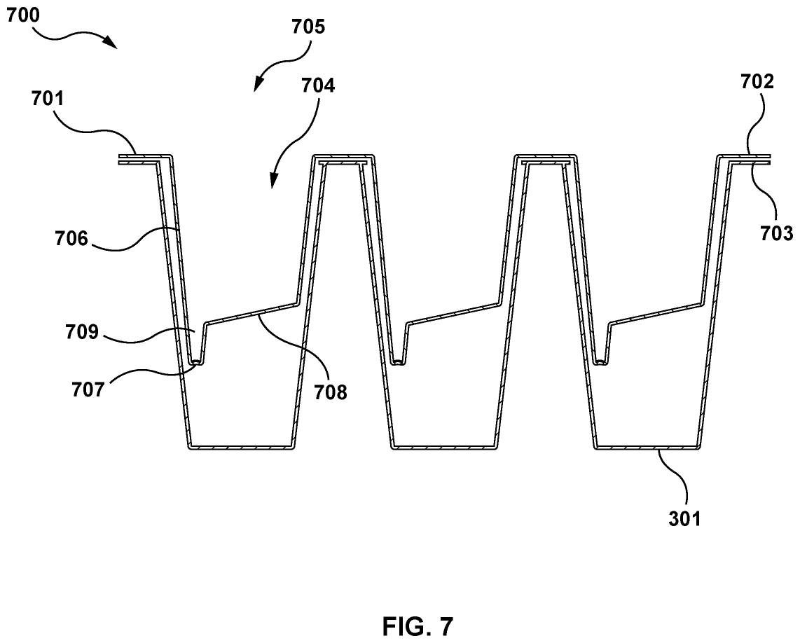

FIG. 7 illustrates a liquid dispensing station consistent with embodiments hereof. A multi-well liquid distribution device 700 (also referred to herein as a multi-well plate overlay device), only a portion of which is shown in FIG. 7, includes a liquid dispensing station 705 and a substrate panel 701, only a portion of which is shown in FIG. 7. The remainder of the multi-well liquid distribution device 700 may include an array of the liquid dispensing stations 705, similar to and optionally including any features of the multi-well liquid distribution devices 100 and 500. The substrate panel 701 includes features and construction similar to those of the substrate panel 101. The substrate panel 701 has a top surface 702, a bottom surface 703, and an array of openings 704. In embodiments, the substrate panel 701 may further include a rim (not shown) extending around the perimeter of the substrate panel 701 and configured to interface with the outer perimeter of a multi-well plate. The array of openings 704 corresponds to an array of dispensing stations 705, wherein each opening 704 corresponds to a dispensing station 705.

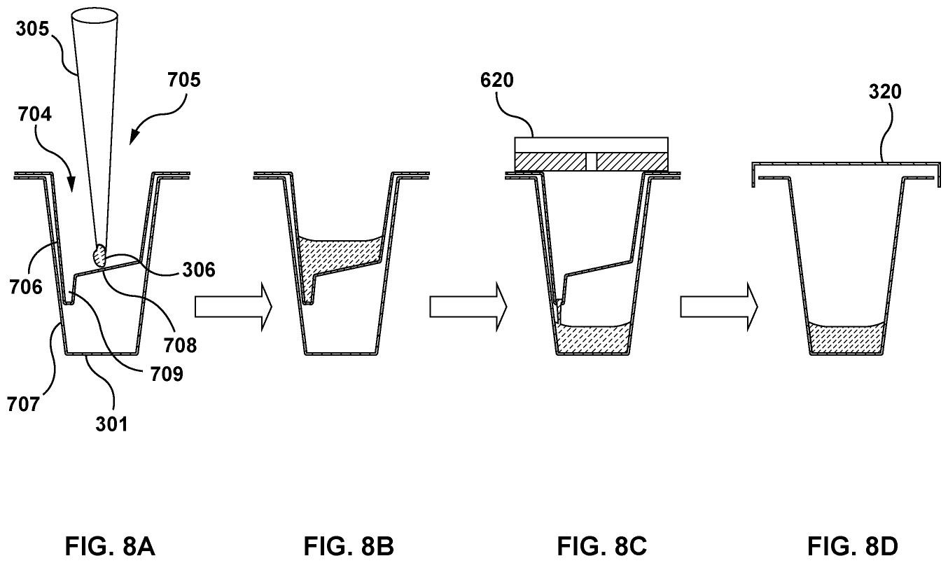

The dispensing stations 705 include dispensing surfaces 706 extending from the substrate panel 701. The dispensing surfaces 706 each include a continuous circumferential surface and have an opening or orifice disposed therein. The dispensing surfaces 706 define a conical frustum with a base at the substrate panel 501 and an apex 708. Offset from the center of the apex 708 surface is disposed a spout 709. The surface of the apex 708 may be arranged at a substantially non-parallel angle with respect to the bottoms of the wells 301 and/or the bottom surface of the panel 701, such that liquid in the dispensing station 705 is drawn by gravity into the spout 709. In further embodiments, the surface of the apex 708 may be arranged at a substantially parallel angle with respect to the bottoms of the wells 301 and/or the bottom surface of the panel 701, such that liquid in the dispensing station 705 may be relocated to the spout 709 via the application of a mechanical force, such as vibration. For instance, the surface of the apex 708 may be arranged such that it has a substantially non-horizontal orientation when the device 700 is overlaid on the plate 300. The spout 709 is tapered from a proximal end at the apex 708 to an orifice 707 located at the distal end. The orifice 707 for a dispensing station 705 (e.g., an insert) is sized and configured to be small enough to prevent passage of the liquids dispensed into the dispensing station 705 from entering the corresponding microplate well absent application of force, e.g., as provided by pressure, to drive it into the microplate well. The orifice is configured to prevent liquid flow and retain liquid droplets when the pressure on the liquid is below a pressure threshold, e.g., via surface tension in the liquid. The orifice is further configured and sized to permit liquid flow and disbursal of the liquid droplets when the pressure on the liquid exceeds a pressure threshold. Accordingly, the size of the orifice 707 may be determined according to the properties, e.g., density, surface tension, viscosity, of liquids that intended to be contained in the dispensing station 705. The opening 704 is large enough to receive the tip of a pipette or pipettor and the dispensing surfaces 706 may receive a liquid droplet dispensed from the tip. The orifice is narrow enough so as to retain a liquid droplet within the dispensing station 705 until and unless force is applied. In embodiments, as discussed with respect to FIG. 8C, the force may be applied in the form of pressure.

In further embodiments, the shape of the dispensing stations 705 may vary without departing from the scope of this disclosure. The dispensing stations 705 are configured with an orifice or opening 707 adjacent to the walls of the assay plate well 301. Although illustrated in FIG. 7 with an apex 708 and a spout 709, alternative shapes may be used to locate an orifice 707 adjacent to the walls of the assay plate well 301. For example, the dispensing station 705 may be formed in the shape of an angled cone, with the orifice or opening at the apex of the cone and located adjacent the walls of the assay plate well 301.

In further embodiments, the orifices 707 may be disposed in a direction that faces the walls of the assay plate wells 301.

In further embodiments, the multi-well plate liquid distribution device 700 may be configured such that the dispensing surfaces 706 of the dispensing stations 705 are suspended directly above, but not inside of, the wells 301. In further embodiments, the multi-well plate liquid distribution device 700 may be suspended above the multi-well plate 300, e.g., via a support structure, without contacting the multi-well plate 300.

FIGS. 8A-8D illustrate a process of dispensing and distributing liquid via a liquid dispensing station consistent with embodiments hereof. The multi-well plate liquid distribution device 700, is placed atop the multi-well plate 300, with the dispensing stations 705 aligning with the wells 301. A pipette 305, manual or automatic, is used to dispense a volume of liquid 306 to the dispensing surfaces 706. The pipette 305 may stay in contact with the volume of liquid 306 during the dispensing action. One or more pipettes 305 are used to dispense volume of liquid 306 to each of the dispensing stations 705 that require liquids. Because the dispensing surfaces 706 are clean, the pipettes 305 may be reused across as many wells 301 as necessary without concern for cross contamination.

After all liquid has been distributed to one or more of the dispensing stations 705, a pressure manifold 620 is placed atop at least a portion of the multi-well plate liquid distribution device 700 and the multi-well plate 300. Pressure is then applied to at least a portion of the dispensing stations 705 through the pressure manifold 620, for example, by a pump. Force is applied to the multi-well plate liquid distribution device 700 in the form of pressure sufficient to expel the volume of liquid 306 through the orifice 707 and into the bottoms of the wells 301. In embodiments, the pressure provided by the pressure manifold 620 may be controlled so as to maintain a controlled flow of liquid through the orifices 707 that does not disturb the contents of the wells 301. In embodiments, the orifices 707 may be oriented, configured, or arranged such that liquid flowing through is directed to the walls of the wells 301.

Because the pressure is applied to all wells 301 at the same time, each volume of liquid 306 enters the bottom of each well 301 at substantially the same time as other volume of liquid 306 enter the bottom of other wells 301, providing a synchronized distribution of liquid into the selected wells 301 of the multi-well plate 300.

In embodiments, the pressure manifold 620 may apply pressure to any number of dispensing stations 705 at one time. Accordingly, liquid distribution into the wells 301 may occur according to any timing pattern. For example, the wells 301 of the multi-well plate 300 may be divided into multiple groups and the pressure manifold 620 may apply pressure to each of the multiple groups with a particular timing pattern to add liquid to the wells 301 according to a specific protocol.

In embodiments, the pressure manifold 620 may be configured to provide pressure to all or a portion of the dispensing stations 705 simultaneously. The pressure manifold 620 may include, for example, multiple zones which may be pressurized to provide pressure to a subset of the dispensing stations 705. The pressure manifold 620 may also be configured such that it does not cover an entirety of the dispensing stations 705 and may be moved between different positions to apply pressure to subsets of the dispensing stations 705.

Upon completion of distribution, the multi-well plate liquid distribution device 500 may be removed and optionally replaced with the plate seal or plate lid 320. The multi-well plate 300 may then be processed in the incubator with the sample/reagent in accordance with the prescribed conditions for the assay.

Accordingly, the multi-well plate liquid distribution device 700 addresses at least three drawbacks of some liquid distribution pipetting techniques. First, the multi-well plate liquid distribution device 700 eliminates timing variations due to sequential addition of sample and/or reagents across a plate. When using the multi-well plate liquid distribution device 700, sample and/or reagents are added sequentially to the multi-well plate liquid distribution device 700, not the multi-well plate 300. Samples/Reagents are then simultaneously dispensed or disbursed to the corresponding wells 301 as described above. Second, when using the multi-well plate liquid distribution device 700, shear forces on the bottoms of the wells 301 are reduced or eliminated. The spout 709 may directs the liquid to the walls of the wells 301 and therefore reduces or eliminates any disturbances of the well contents. The spout 709 may also direct the liquid to the edge of the wells 301 and therefore reduce or eliminates any disturbances of well contents located in the center of the wells 301. Third, when using the multi-well plate liquid distribution device 500, cross-contamination between wells 301 during sequential addition of reagents to multiple wells 301 using the same set of pipettor tips is eliminated. Reagents are added sequentially to the multi-well plate liquid distribution device 500, not the multi-well plate 300. The dispensing surfaces 506 of the multi-well plate liquid distribution device 500 never contact the contents of the multi-well plate 300. Thus, even with the re-use of pipette tips, there is no possibility of cross-contamination or carryover between wells 301.

In further embodiments, the orifices 507 and 707 may be configured to include valves. For example, the valves may be duckbill check valves (not shown) with the “bill” directed downwards towards the well 301 or to the walls of the well 301. The cracking pressure threshold of the valve is designed to be at least 0.5 psi, although greater or smaller pressures may also be used. Liquid is dispensed into the holding well and retained in place by the valve. The valve remains closed until the external pressure manifold 620 interfaces with the top of the respective multi-well liquid distribution device 500 or 700 and positive pressure is applied sufficient to open the valve and dispense the contents of the holding well into the corresponding microplate well.

A matrix of check valves (such as a 12×8 matrix or other size matrix corresponding to a multi-well plate 300) may be molded as a single part that may be then bonded to, snapped to, or otherwise attached to a substrate panel including openings and dispensing stations corresponding to wells of a multi-well plate. In another embodiment, individual valves may be bonded to, snapped to, or otherwise attached to individual dispensing stations of a multi-well liquid distribution device. Alternately, it may be possible to insert mold a rigid supporting plate for the matrix of check valves. In addition to pressure, alternate means of opening the check valve may include application of mechanical clamping force to the top of the insert to deform the material of the check valve.

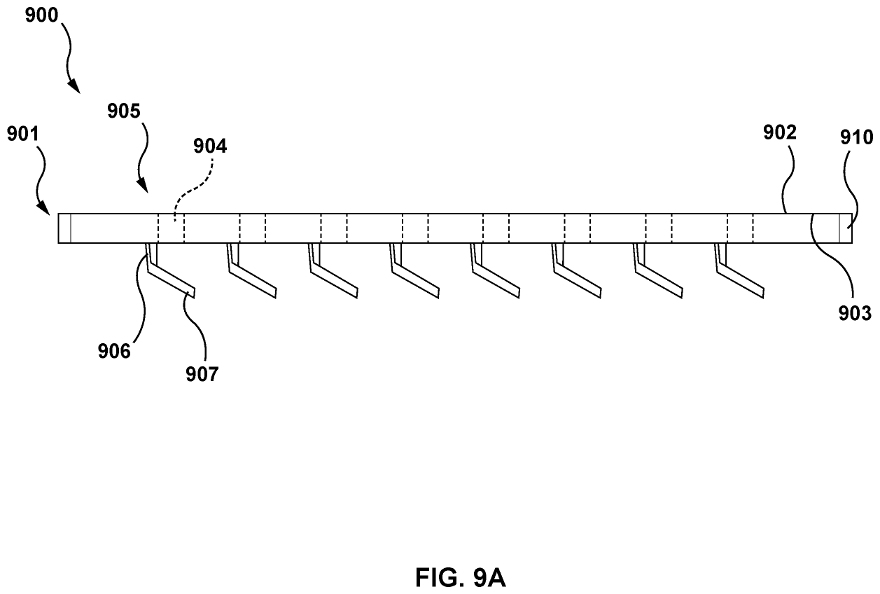

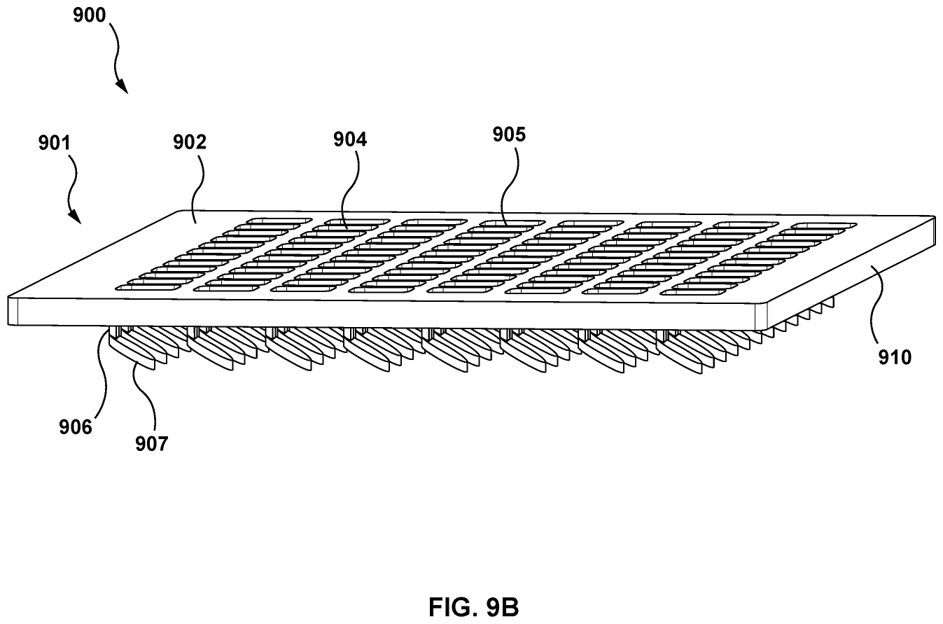

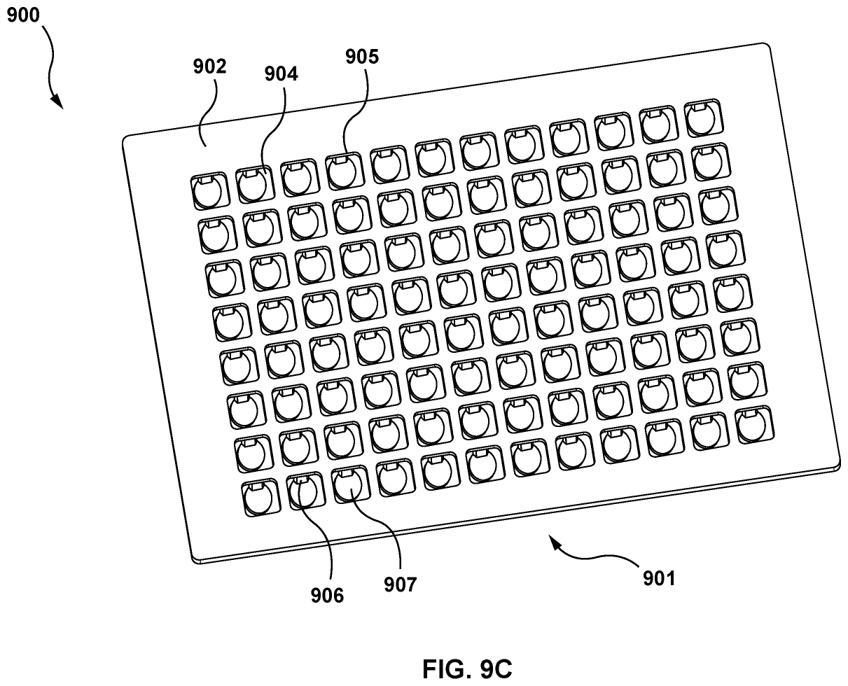

FIGS. 9A-9C illustrate a multi-well liquid distribution device consistent with embodiments hereof. The multi-well plate liquid distribution device 900 (also referred to herein as a multi-well plate overlay device) is configured to overlay the multi-well plate 300. The multi-well plate liquid distribution device 900 includes a substrate panel 901, similar to the substrate panels 101, 501, 701, having a top surface 902 and a bottom surface 903 and an array of openings 904. In embodiments, the substrate panel 901 may further include a rim 910 extending around the perimeter of the substrate panel 901 and configured to interface with the outer perimeter of the multi-well plate 300. The array of openings 904 corresponds to an array of dispensing stations 905, wherein each opening 904 corresponds to a dispensing station 905.

The dispensing stations 905 include at least one support rib 906 extending from the substrate panel 901 and a dispensing surface 907 supported by the at least one support rib 906. The perimeter of the dispensing surface 907 is completely open except for the location at which the support rib 906 is connected. The support rib 906 connects to and supports the dispensing surface 907. The support rib 906 is relatively thin compared to the length of the outer perimeter of the dispensing surface 907. For example, the support rib 906 may occupy less than 60%, less than 40%, less than 20%, less than 15%, less than 10%, less than 5%, and/or less than 2% of the perimeter of the dispensing surface 907, although other percentages are contemplated as well. The dispensing surfaces 907 may be circular, rectangular (e.g., square), elliptical, or any other suitable shape. In embodiments, the dispensing surface 907 may have a shape identical with or similar to that of the bottom of the wells 301. The dispensing surfaces 907 may be substantially flat, as shown in FIG. 9A and/or may have a contour, such as, for example, a convex or concave contour. In further embodiments, the dispensing surfaces 907 be flat. The dispensing surface 907 may include various features to promote distribution of the dispensed liquid volume. For example, in embodiments, the dispensing surface 107 may comprise a material or have a coating that is hydrophilic, causing any water-based liquid placed thereon to quickly run off the surface. In further embodiments, the dispensing surface 107 may be textured with a surface texture that promotes liquid run-off. The dispensing surface 907 is disposed at a substantially non-parallel angle with respect to the bottom surface 903 of the substrate panel. Thus, when the multi-well liquid distribution device 900 is overlaid on the multi-well assay, the dispensing surfaces 907 are arranged at a substantially non-parallel angle with respect to the bottoms of the wells 301. The substantially non-parallel angle may be greater than 5°, greater than 10°, greater than 20°, greater than 30°, and/or greater than 45° relative to, e.g., the bottom surface 903 of the substrate panel, although other angles are contemplated as well. The substantially non-parallel angle is selected to permit touch-off dispensing of the liquid being dispensed by the pipette tips to allow the dispensed volume to roll off into the well as soon as it is dispensed. This configuration may eliminate the need to provide force to dispense or disburse the liquid from the dispensing surfaces 907.

The multi-well liquid distribution device 900 is configured to facilitate liquid dispensing, disbursement, and/or distribution when the multi-well plate overlay device and an associated multi-well plate are maintained in a substantially stable state. Accordingly, the liquid may be dispensed, disbursed, or distributed from the dispensing surfaces 907 while maintaining the multi-well plate overlay device in a substantially stable state. For example, at least 85%, at least 90%, at least 95%, or at least 99% of liquids applied to the dispensing surface 907 may be dispensed while the multi-well plate is maintained in a substantially stable state. In a “substantially stable state” the multi-well plate overlay device and associated multi-well plate may be free from movement or forces deliberately employed to facilitate liquid dispensing, disbursing, and/or distribution. For example, in a substantially stable state, the multi-well plate overlay device and associated multi-well plate may be free from oscillations, vibrations, shaking or other movements employed to facilitate liquid dispensing, disbursing, and/or distribution. In a substantially stable state, the multi-well plate overlay device and associated multi-well plate may still move, for example, due to mechanical vibrations of laboratory equipment, due to plate movement or carriage devices configured to facilitate movement or transfer of a multi-well plate within or between laboratory devices, due to incident vibrations caused by personnel movement in or near a laboratory, and/or due to other forces or movement in the laboratory environment. Such movements, however, are not regularly or consistently induced for the purpose of facilitating liquid dispensing, disbursing, and/or distribution. Thus, the liquid may be dispensed, disbursed, or distributed from the dispensing surfaces 907 without applying any substantial distributional mechanical force or movement to the multi-well plate overlay device and associated multi-well plate that is employed to cause liquid dispensing, disbursing, and/or distribution.

Although the multi-well liquid distribution device 900 is configured to facilitate liquid dispensing, disbursement, and/or distribution when the multi-well plate overlay device and an associated multi-well plate are maintained in a substantially stable state, this does not preclude the use of the multi-well liquid distribution device 900 in environments that are not substantially stable.

In further embodiments, force may be provided after liquid application, for example, to ensure that all liquid has been disbursed from the dispensing surfaces 907 or to distribute only a subset of the liquid each time the force is applied.

The dispensing surfaces 907 are configured and arranged such that the lowest portions of the dispensing surfaces 907 (i.e., the portions of the perimeters farthest away from the substrate panel 901) are adjacent to the walls of the wells 301. Thus, liquid dispensed to the dispensing surfaces 907 runs down the angled dispensing surfaces 907 and is disbursed to the walls of the wells 301, thus preventing the liquid from directly falling to the bottom of the wells 301.

The multi-well plate liquid distribution device 900 addresses at least two of the drawbacks of conventional liquid distribution techniques. The multi-well plate liquid distribution device 900 eliminates potential cross-contamination issues because the liquid is dispensed only to the clean dispensing surfaces 907 and the pipettes never come in contact with the contents of the wells 301. Further the dispensing surfaces 907 are configured to disburse the liquid to the walls of the wells 301, and thus reduce or eliminate the disturbance of contents of the wells 301.

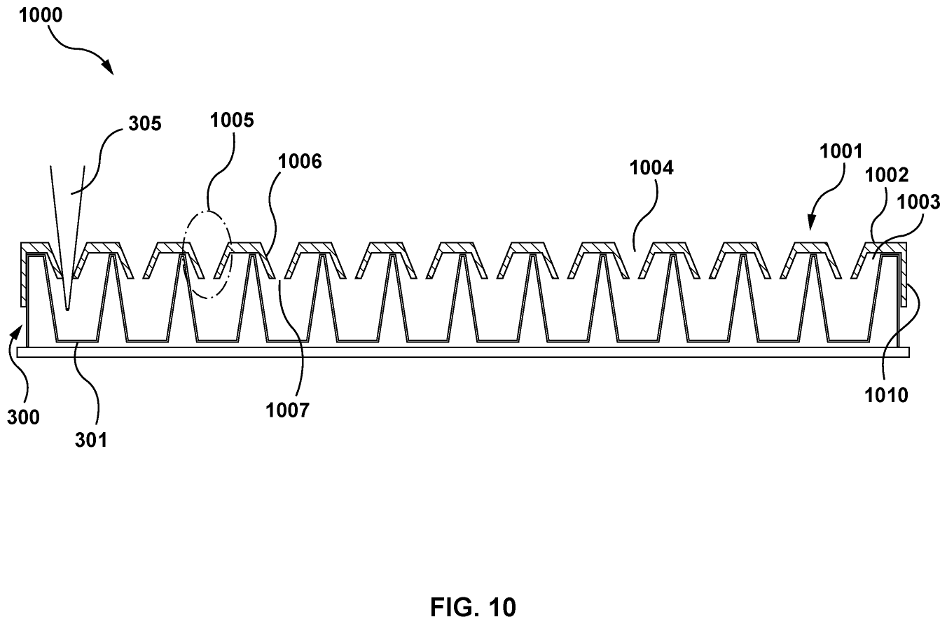

FIG. 10 illustrates a multi-well plate liquid distribution device 1000 (also referred to herein as a multi-well plate overlay device) in plan view consistent with embodiments hereof. The multi-well plate liquid distribution device 1000 is configured to overlay a multi-well plate 300 having multiple wells 301. The multi-well plate liquid distribution device 1000 includes a substrate panel 1001 having a top surface 1002 and a bottom surface 1003 and an array of openings 1004. In embodiments, the substrate panel 1001 may further include a rim 1010 extending around the perimeter of the substrate panel 1001 and configured to interface with the outer perimeter of a multi-well plate. The array of openings 1004 corresponds to an array of dispensing stations 1005, wherein each opening 1004 corresponds to a dispensing station 1005.

Each dispensing station 1005 includes tapered walls 1006. The tapered walls 1006 are configured to guide one or more pipette tips into one or more corresponding wells 301. The tapered walls 1006 of the dispensing stations 1005 taper to a pipette opening 1007 large enough to admit the tip of a pipette 305 but not large enough to admit a body of the pipette 305. Accordingly, the pipette opening 1007 at the apex of the tapered walls 1006 maintains the pipette tips at a specific defined distance from the bottoms of the wells 301. Because the pipette tips are maintained a defined distance away from the well bottoms the liquid being dispensed does not contact the well bottom and the pipettes 306 at the same time. Thus, the same set of pipette tips can be used to dispense reagents across the multi-well plate 300 without fear of contamination of the pipette tips with the contents of any well and cross-contamination between wells.

In addition, the openings 1004 and the pipette openings 1007 for each of the dispensing stations 1005 are offset from the center of the wells 301. That is, the tapered walls 1006 of the dispensing stations 1005 are not co-axial with the wells 301 of the multi-well plate 300. The offset moves the tip of the pipette 305 away from the center of the well 301, such that liquid is dispensed to the side of the wells 301 and away from the centers. This avoids dispensing fluid directly on coated spots in the center of wells 301 of the multi-well plates 300.

In a further embodiment, the dispensing stations 1005 may include openings 1004 without the tapered walls 1006. The openings 1004 may be sized to admit the tips of the pipettes 306 only to a certain distance to maintain the tips a defined distance above the bottoms of the wells 301. The openings 1004 may be offset or non-co-axial with the well bottoms, as described above, to permit liquid disbursement to the sides of the wells 301. In further embodiments, the openings 1004 may be configured to be centered or substantially centered (i.e., co-axial) with respect to the bottoms of the wells 301.

Accordingly, the multi-well plate liquid distribution device 1000 addresses at least two drawbacks of some liquid distribution pipetting techniques. First, when using the multi-well plate liquid distribution device 1000, liquids are disbursed to the sides of the multi-well plate 300, not the well centers, and therefore shear effects on assay performance are minimized. Second, when using the multi-well plate liquid distribution device 1000, cross-contamination between wells 301 during sequential addition of reagents to multiple wells 301 using the same set of pipettor tips is eliminated. The liquid dispensed by the tips of the pipettes 306 is never in contact with both the pipettes 306 and the bottoms of the wells 301 at the same time, thereby eliminating the possibility of cross contamination. These advantages of the multi-well plate liquid distribution device 1000 may be provided in both manual and automated pipetting arrangements.

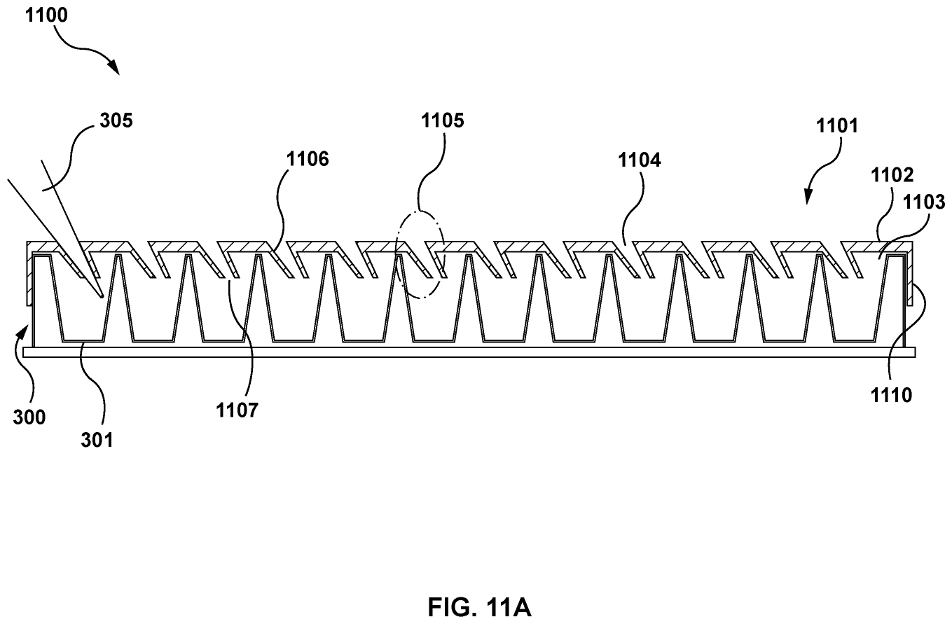

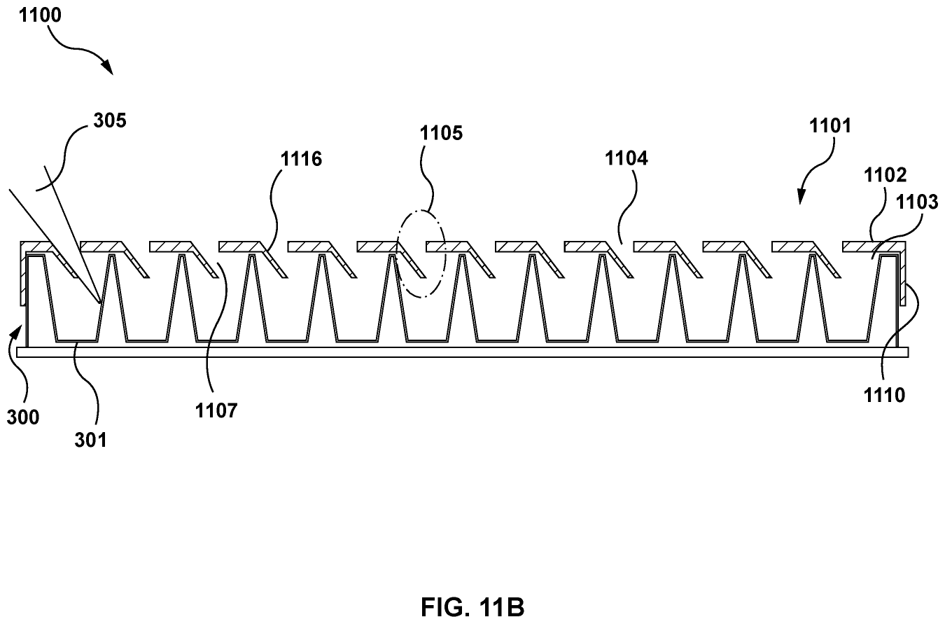

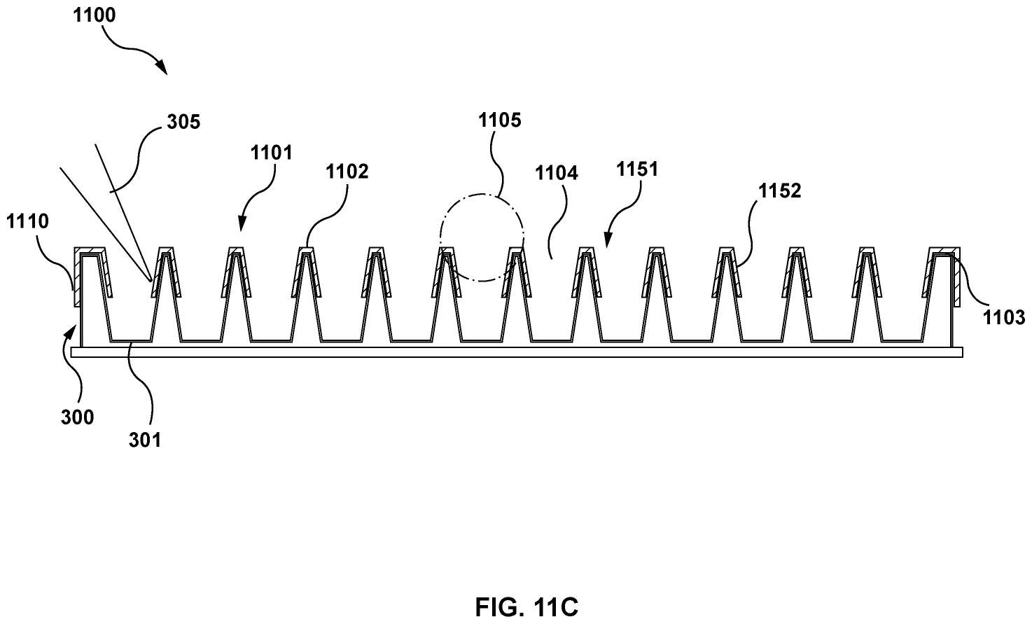

FIGS. 11A-11C illustrate three variations of a multi-well plate liquid distribution device 1100 (also referred to herein as a multi-well plate overlay device) in plan view consistent with embodiments hereof. The multi-well plate liquid distribution device 1100 is configured to overlay a multi-well plate 300 having multiple wells 301. The multi-well plate liquid distribution device 1100 includes a substrate panel 1101 having a top surface 1102 and a bottom surface 1103 and an array of openings 1104. In embodiments, the substrate panel 1101 may further include a rim 1110 extending around the perimeter of the substrate panel 1101 and configured to interface with the outer perimeter of a multi-well plate. The array of openings 1104 corresponds to an array of dispensing stations 1105, wherein each opening 1104 corresponds to a dispensing station 1105. The multi-well plate liquid distribution devices 1100 of FIGS. 11A-11C may provide advantages, as discussed below, in both manual and automated pipetting arrangements. In embodiments, the multi-well plate liquid distribution device 1100 may have surface properties, created, e.g., via material selection and/or surface preparation, such that the fluids dispensed on to the surface easily roll off into the plate. The surfaces of the multi-well plate liquid distribution device 1100 configured to receive fluids may have low surface energy and/or a texture such that there is minimal adhesion of liquid to its surface so no droplets are left behind.

FIG. 11A illustrates an embodiment wherein each dispensing station 1105 includes tapered walls 1106. The tapered walls 1106 are configured to guide one or more pipette tips into one or more corresponding wells 301. The tapered walls 1106 define a continuous circumferential surface of the dispensing stations 1105 and taper to a pipette opening 1107 large enough to admit the end of a tapered tip of a pipette 305 while still being small enough to prevent the tip of the pipette 305 from passing completely through the pipette opening 1107. Additionally, the tapered walls 1106 are arranged so as to have an axis that is substantially non-perpendicular with respect to the bottoms of the wells 301. This angle provides a configuration for the tapered walls 1106 such that each pipette opening 1107 is adjacent to a wall of a respective well 301. Accordingly, the tapered walls 1106 maintain the pipette tips a specific defined distance from the side walls of the wells 301. The specific defined distance is selected to permit liquid dispensed from the pipettes 306 to contact both the pipettes 306 and the walls of the wells 301 at the same time. This type of touch pipetting, as discussed above, can improve the accuracy and precision of liquid dispensing. Because the pipette tips are maintained a defined distance away from the well bottoms the possibility of well cross-contamination is reduced or eliminated. Thus, the same set of pipette tips can be used to dispense reagents across the multi-well plate 300 without fear of contamination of the pipette tips with the contents of any well and cross-contamination between wells.

In further embodiments, the specific defined distance is selected to prevent liquid dispensed from the pipettes 306 to contact both the pipettes 306 and the walls of the wells 301 at the same time.

In further embodiments, the walls of the dispensing stations 1105 are not tapered. Tapering may not be necessary, for example, because pipette tips are often tapered. As the pipette tip is inserted further into the dispensing station 1105, the larger circumference of the pipette away from the tip of the pipette will arrest further insertion of the pipette. Accordingly, a dispensing station 1105 may be provided with a circumference selected to maintain the pipette tips a specific defined distance from the side walls of the wells 301.

FIG. 11B illustrates an embodiment wherein each dispensing station 1105 includes partial walls 1116. The partial walls 1116 are configured to guide one or more pipette tips into one or more corresponding wells 301. The partial walls 1116 define a partially circumferential surface of the dispensing stations 1105 and taper to a pipette opening 1107 large enough to admit the end of a tapered tip of a pipette 305 while still being small enough to prevent the tip of the pipette 305 from passing completely through the pipette opening 1107. The partial walls 1116 may describe an arc less than 180 degrees but greater than 90, 100, 110, 120, 130, 140, 150, 160, or 170 degrees.

FIG. 11C illustrates an embodiment wherein each dispensing station 1105 is formed between well wall sleeves 1151. The well wall sleeves 1151 include sleeve walls 1152 that extend downwards from the top surface 1102 and surround the opening 1104 to define each dispensing station 1105. The sleeve walls 1152 provide a continuous circumferential surface with a pipette opening disposed therein and extend a predefined distance into the wells 301. The predefined distance may be, for example, between 20-80% of the well depth, between 30-70% of the well depth, and/or between 40-60% of the well depth. Other predefined distances may be selected. In contrast to the tapered walls 1106/1116 illustrated in FIGS. 11A and 11B, which are configured to guide the pipette 305, the sleeve walls 1152 define a pipette opening larger than the pipette 305 such that the pipette 305 can be used to deposit fluid in the sample wells whilst contacting the sleeve walls 1152. The sleeve walls 1152 serve to prevent the pipette 305 from contacting the walls of the wells 301 during pipetting by covering the walls of the wells 301. Thus, in this embodiment, the multi-well plate liquid distribution device 1100 may be understood as an overlay that covers the top surface and well walls to a predefined distance of the multi-well plate 300. The sleeve walls 1152 may be tapered, e.g., as shown in FIG. 11C or may be straight. The sleeve walls 1152 may conform to the well walls of the multi-well plate 300 and/or may be configured so as not to follow the angle of the well walls.

During pipetting, touch pipetting techniques (by a user or automated system) may be employed to dispense precise amounts of fluids to the sleeve walls 1152 (which thus act as dispensing surfaces). This type of touch pipetting, as discussed above, can improve the accuracy and precision of liquid dispensing. Because the pipette tips are prevented from contacting the well walls, the possibility of well cross-contamination is reduced or eliminated. Thus, the same set of pipette tips can be used to dispense reagents across the multi-well plate 300 without fear of contamination of the pipette tips with the contents of any well and cross-contamination between wells.

Accordingly, the multi-well plate liquid distribution device 1100 addresses at least three drawbacks of some liquid distribution pipetting techniques. First, when using the multi-well plate liquid distribution device 1100, reagents are disbursed to the side walls of the multi-well plate 300, not the plate bottom and therefore shear effects on assay performance are minimized. Second, when using the multi-well plate liquid distribution device 1100, cross-contamination between wells 301 during sequential addition of reagents to multiple wells 301 using the same set of pipettor tips is eliminated or reduced. Even with the re-use of pipette tips, there is no possibility of cross-contamination or carryover between wells 301. Finally, when using the multi-well plate liquid distribution device 1100, additional consistency is provided for the manual positioning of pipette tips. Human error and variability may be reduced due to the use of the different embodiments of the multi-well plate liquid distribution device 1100. The multi-well plate liquid distribution devices 1100 having the features shown in FIGS. 11A and 11B may reduce manual pipetting variability through aligning and maintaining position of the pipette 305, while the multi-well plate liquid distribution device 1100 having the features shown in FIG. 11C may reduce manual pipetting variability through preventing contact between the pipette 305 and the well walls. In embodiments, the multi-well plate liquid distribution device 1100 may also be used in automatic pipetting arrangements, for example, by arranging the multi-well plate and the automated pipettes at a non-perpendicular angle to one another.

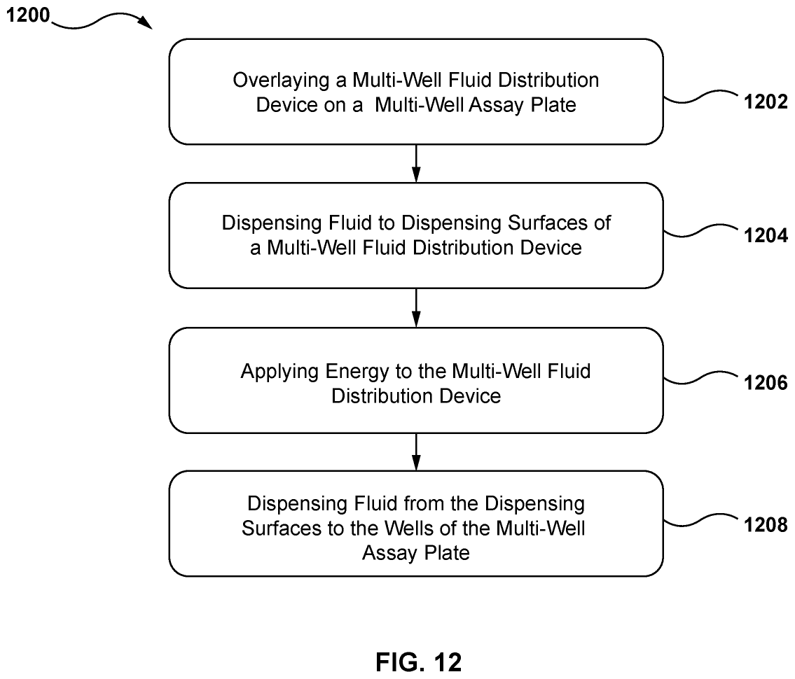

FIG. 12 is a flow chart illustrating a method of dispensing and distributing liquids to a micro-well assay plate consistent with embodiments hereof. The process 1200 of dispensing and distributing liquids to a micro-well assay plate may be carried out via any of the multi-well liquid distribution devices described herein. Although described in a specific order with a specific number of operations, the process 1200 may altered to include fewer operations, a different order of operations, and/or more operations without departing from the scope of this disclosure.

In an operation 1202, the process 1200 includes overlaying a multi-well liquid distribution device on a multi-well plate. As described above, any multi-well liquid distribution device described herein may be used with a multi-well plate.

In an operation 1204, the process 1200 includes dispensing amounts of liquids onto each dispensing surface of an array of dispensing stations of the multi-well liquid distribution device. The dispensed amount may be predetermined or determined during dispensing. This procedure is described above, for example with respect to FIGS. 4, 6, and 8. In embodiments, predetermined amounts of liquids are dispensed to multiple dispensing surfaces of multiple wells by a single pipette without cross-contamination between the wells.

In an operation 1206, the process 1200 includes applying force to the to the multi-well plate, the multi-well liquid distribution device, and/or to the liquid volumes dispensed to the multi-well liquid distribution device. As described herein, the force may be applied in the form of, for example, mechanical motion and/or pressure. The applied force serves to release the liquid from the dispensing surfaces, as described above, for example with respect to FIGS. 4, 6, and 8.

In an operation 1208, the process 1200 includes causing, in response to the applied force, distribution of the predetermined amounts of liquids from each dispensing surface to the respective wells of the multi-well plate. The liquid is distributed from each dispensing surface to the respective wells, as described above, for example with respect to FIGS. 4, 6, and 8.

In embodiments, liquid distribution occurs substantially simultaneously for a plurality of the wells in the multi-well plate. Substantially simultaneously means that each well receives liquid within 5 seconds, within 3 seconds, or within 1 second. In further embodiments, every well of the multi-well plate that receives liquid receives distributed liquid substantially simultaneously.

In embodiments, a substantial portion, e.g., greater than 50%, greater than 70%, and/or greater than 90%, of the liquid is distributed to the walls of the multi-well plate wells, although other percentages are contemplated as well. In embodiments, distribution to the walls reduces or eliminates disturbances or perturbations of the well contents during liquid distribution. In further embodiments, a substantial portion, e.g., greater than 50%, greater than 70%, and/or greater than 90%, of the liquid is distributed directly to the bottom of the multi-well plate wells without contacting the walls first, although other percentages are contemplated as well.

In further embodiments, the following features may be applied to any of the multi-well liquid distribution devices 100, 500, 700, and 900 discussed herein.

The multi-well liquid distribution devices are compatible with plate handling automation and with manual use. In embodiments, different versions of the multi-well liquid distribution devices may be configured for manual and for automated used. For example, multi-well liquid distribution devices for automation may have specific strength and handling requirements. Multi-well liquid distribution devices for manual use may be less expensive and be constructed with lower strength demands. The multi-well liquid distribution devices may be configured to nest with one another for packaging and storage considerations. The multi-well liquid distribution devices may be configured to fit between a multi-well plate and the plate lid or plate seal of the multi-well plate.

Embodiments of the disclosure may be compatible with a wide variety of plates. For example, 96 well plates, 384 well plates, and any other size plates may be compatible with embodiments as described herein. Further, different shaped wells, e.g., round, square, rectangular, oval, etc., may be used with embodiments described herein. Additionally, multi-well fluid distribution plates as described herein may be configured to provide dispensing stations to any subset of wells in multi-well plate. Further, the overlay can include a subset of stations (e.g., every fourth well, left half of the plate only, etc.). This subset of stations can be employed, for example, for applications that only require partial pipetting (e.g., if some of the wells are for calibrators and/or controls, some wells are unused, etc.), thus requiring pipetting only into a subset of the entire plate.

In further embodiments, the liquid distribution methods described herein may be used with solids as well. For example, amounts of solids in the form of powders or other particulates may be deposited on the dispensing surfaces described herein. The force applied, e.g., pressure and/or mechanical motion, may then be used to distribute the solid from the dispensing surface to the well.

In embodiments, the dispensing surface may include two, three, or more sub-surfaces at equal heights or unequal heights with respect to the well bottom. For example, different liquids may be applied to each of multiple sub-surfaces. In other examples, the liquids can be the same. When force is applied to the fluid distribution device including the multiple sub-surfaces, the two liquids are then disbursed into the well where they are free to mix. Thus, the use of multiple sub-surfaces may be used to select, delay, and/or otherwise coordinate the timing of liquid mixture and thus could be used to adjust the timing and synchronization of chemical reactions associated with the liquid mixing.

In embodiments, the dispensing surfaces of the multi-well liquid distribution devices may be selected to have a low surface energy to discourage spreading of samples and reagents that are dispensed onto it. Alternately, coatings or plasma-based surface treatments may be applied to the inserts to obtain desired surface energy and other properties.

In embodiments, the various multi-well liquid distribution devices described herein may be configured to handle differing volumes of liquid. For example, the multi-well liquid distribution device 100 may be more suitable for liquid volumes less than about 50 μL, while the multi-well liquid distribution devices 500 and 700 may be more suitable for delivering larger volumes to the wells. Further, the multi-well liquid distribution device 900 may be suitable for delivering even larger volumes, as it permits continuous flow.

In embodiments, the arrays of dispensing stations in the multi-well liquid distribution devices 100, 500, 700, and 900 may be provided in 8×1, 2×2, or 4×4 formats instead of the standard 8×12, 96 well format to support partial plate runs. In embodiments, any suitable array size may be provided.

While various embodiments have been described above, it should be understood that they have been presented only as illustrations and examples of the present technology, and not by way of limitation. It will be apparent to persons skilled in the relevant art that various changes in form and detail can be made therein without departing from the spirit and scope of the present technology. Thus, the breadth and scope of the present technology should not be limited by any of the above-described exemplary embodiments. It will also be understood that each feature of each embodiment discussed herein can be used in combination with the features of any other embodiment. Embodiments of the present technology include at least the following.

Embodiment 1 is a device configured to overlay a multi-well plate, the device comprising a substrate panel having a top surface and a bottom surface and including an array of openings; an array of dispensing stations, each dispensing station corresponding to one of the array of openings and including: at least one support rib extending from the substrate panel, a dispensing surface supported by the at least one support rib.

Embodiment 2 includes the features of embodiment 1, wherein the array of openings and the array of dispensing stations are configured to correspond to at least a portion of an array of wells in the multi-well plate.

Embodiment 3 includes the features of any of embodiments 1-2, wherein the at least one support rib is configured to support the dispensing surface above a bottom of a well in the multi-well plate when at least a portion of the bottom surface of the substrate panel contacts a multi-well plate top surface.

Embodiment 4 includes the features of any of embodiments 1-3, wherein the dispensing surface is convex.

Embodiment 5 includes the features of any of embodiments 1-4, wherein the dispensing surface is concave.

Embodiment 6 includes the features of any of embodiments 1-4, wherein the dispensing surface is substantially flat.

Embodiment 7 includes the features of any of embodiments 1-4, wherein the dispensing surface includes a raised rim.

Embodiment 8 includes the features of any of embodiments 1-7, wherein the dispensing surface is substantially parallel to the bottom surface of the substrate panel.

Embodiment 9 includes the features of any of embodiments 1-8, wherein the dispensing surface is disposed at a substantially non-parallel angle with respect to the bottom surface of the substrate panel.

Embodiment 10 includes the features of any of embodiments 1-9, wherein the dispensing surface is configured to facilitate fluid dispensing when the device is maintained in a substantially stable state.

Embodiment 11 includes the features of any of embodiments 1-10, wherein side portions of the dispensing surface are substantially open.

Embodiment 12 includes the features of any of embodiments 1-11, wherein a surface texture of the dispensing surface is configured to retain a liquid droplet placed thereon via surface tension, preventing the liquid droplet from exiting the dispensing surface via the side portions.

Embodiment 13 includes the features of any of embodiments 1-13, wherein the substrate panel is configured to overlay the multi-well plate with the array of dispensing stations extending into respective wells of the multi-well plate.

Embodiment 14 includes the features of any of embodiments 1-13, wherein the array of dispensing stations is configured, when liquid droplets are placed on respective dispensing surfaces of the array of dispensing stations, to release the liquid droplets into the respective wells when a mechanical force is applied to the multi-well plate.

Embodiment 15 includes the features of any of embodiments 1-14, wherein the mechanical force includes at least one of a shaking or vibrating force.

Embodiment 16 includes a device configured to overlay a multi-well plate, the device comprising a substrate panel having a top surface and a bottom surface and including an array of openings; an array of dispensing stations, each dispensing station corresponding to one of the array of openings and including: at least one dispensing surface extending from the substrate panel, the at least one dispensing surface including a continuous circumferential surface with an opening disposed therein.

Embodiment 17 includes the features of embodiment 16, wherein the at least one dispensing surface is conical and the opening is disposed at an apex of the at least one dispensing surface.

Embodiment 18 includes the features of any of embodiments 16-17, wherein the opening is sized to permit liquid flow at a threshold pressure and prevent liquid flow below the threshold pressure.

Embodiment 19 includes the features of any of embodiments 16-18, wherein the opening further includes a duckbill valve.

Embodiment 20 includes the features of any of embodiments 16-19, wherein the at least one dispensing surface defines a substantially conical frustum and includes a spout located at a perimeter of a conical frustum apex, and wherein the opening is located at a spout apex.

Embodiment 21 includes the features of any of embodiments 16-20, wherein the substrate panel is configured to overlay the multi-well plate with the array of dispensing stations extending into respective wells of the multi-well plate.

Embodiment 22 includes the features of any of embodiments 16-21, wherein the array of dispensing stations is configured to release liquid from the array of dispensing stations into the respective wells when pressure is applied to the multi-well plate.

Embodiment 23 includes a device configured to overlay a multi-well plate, the device comprising: a substrate panel having a top surface and a bottom surface and including an array of openings; and an array of dispensing stations, each dispensing station corresponding to one of the array of openings and including: at least one tapered wall extending from the substrate panel, the at least one tapered wall defining a continuous circumferential surface with a pipette opening disposed therein.

Embodiment 24 includes the features of embodiment 23, wherein the array of openings and the array of dispensing stations are configured to correspond to at least a portion of an array of wells in the multi-well plate.

Embodiment 25 includes the features of any of embodiments 23-24, wherein the pipette opening is configured to admit a pipette tip and maintain the pipette tip a defined distance from a bottom of a corresponding well of the multi-well plate.

Embodiment 26 includes the features of any of embodiments 23-25, wherein the pipette opening and a respective opening of the array of dispensing stations are not co-axial with a corresponding well of the multi-well plate and the pipette opening is configured to direct a flow of liquid from a pipette tip to a side of a bottom of the corresponding well of the multi-well plate.

Embodiment 27 includes the features of any of embodiments 23-26, wherein the pipette opening is configured to admit a pipette tip and maintain the pipette tip a defined distance from a side wall of a corresponding well of the multi-well plate and wherein the at least one tapered wall has an axis that is substantially non-perpendicular to a bottom of the corresponding well of the multi-well plate and is configured to direct a liquid flow from the pipette tip to the side wall of the corresponding well.

Embodiment 28 includes the features of embodiment 24, wherein the at least one tapered wall is configured to overlay well walls of the multi-well plate to a predetermined depth.

Embodiment 29 includes a method of dispensing liquid to a multi-well plate via a pipette, the method comprising: dispensing predetermined amounts of liquids onto each dispensing surface of an array of dispensing stations of a multi-well plate overlay device; applying mechanical force to the multi-well plate; and causing, in response to the mechanical force, distribution of the predetermined amounts of liquids from each dispensing surface to respective wells of the multi-well plate.

Embodiment 30 includes a method of dispensing liquid to a multi-well plate via a pipette, the method comprising: dispensing predetermined amounts of liquids onto each dispensing surface of an array of dispensing stations of a multi-well plate overlay device; applying pressure to the multi-well plate via a pressure manifold; and causing, in response to the pressure, distribution of the predetermined amounts of liquids from each dispensing surface to respective wells of the multi-well plate.

Embodiment 31 includes a method of dispensing liquid to a multi-well plate via a pipette, the method comprising: dispensing predetermined amounts of liquids onto each dispensing surface of an array of dispensing stations of a multi-well plate overlay device, each dispensing surface being arranged at a substantially non-parallel angle with respect to a bottom surface of the multi-well plate overlay device; and causing distribution of the predetermined amounts of liquids from each dispensing surface to respective wells of the multi-well plate.

Embodiment 32 includes the features of embodiment 31, wherein causing distribution includes maintaining the multi-well plate overlay device in a substantially stable state.

Embodiment 33 includes the features of any of embodiments 31-32, wherein causing distribution is performed without applying distributional mechanical force to the multi-well plate overlay device.

Embodiment 34 includes a device configured to overlay a multi-well plate, the device comprising: a substrate panel having a top surface and a bottom surface and including an array of openings; an array of dispensing stations, each dispensing station corresponding to one of the array of openings and including: at least one tapered wall extending from the substrate panel, the at least one tapered wall defining a partially circumferential surface with a pipette opening disposed therein.

Embodiment 35 is a device configured to overlay a multi-well plate, the device comprising: a substrate panel having a top surface and a bottom surface and including an array of openings; and an array of dispensing stations, each dispensing station corresponding to one of the array of openings and including: at least one wall extending from the substrate panel and configured to overlay well walls of the multi-well plate to a predetermined depth, the at least one wall defining a continuous circumferential surface with a pipette opening disposed therein.

1. A device configured to overlay a multi-well plate, the device comprising
a substrate panel having a top surface and a bottom surface and including an array of openings;
an array of dispensing stations, each dispensing station corresponding to one of the array of openings and including:
at least one support rib extending from the substrate panel,
a dispensing surface supported by the at least one support rib.

2. The device of claim 1, wherein the array of openings and the array of dispensing stations are configured to correspond to at least a portion of an array of wells in the multi-well plate.

3. The device of claim 1, wherein the at least one support rib is configured to support the dispensing surface above a bottom of a well in the multi-well plate when at least a portion of the bottom surface of the substrate panel contacts a multi-well plate top surface.

4-7. (canceled)

8. The device of claim 1, wherein the dispensing surface is substantially parallel to the bottom surface of the substrate panel.

9. The device of claim 1, wherein the dispensing surface is disposed at a substantially non-parallel angle with respect to the bottom surface of the substrate panel.

10. (canceled)

11. The device of claim 1, wherein side portions of the dispensing surface are substantially open.

12. The device of claim 11, wherein a surface texture of the dispensing surface is configured to retain a liquid droplet placed thereon via surface tension, preventing the liquid droplet from exiting the dispensing surface via the side portions.

13. The device of claim 1, wherein the substrate panel is configured to overlay the multi-well plate with the array of dispensing stations extending into respective wells of the multi-well plate.

14. The device of claim 13, wherein the array of dispensing stations is configured, when liquid droplets are placed on respective dispensing surfaces of the array of dispensing stations, to release the liquid droplets into the respective wells when a mechanical force is applied to the multi-well plate.

15. (canceled)

16. A device configured to overlay a multi-well plate, the device comprising
a substrate panel having a top surface and a bottom surface and including an array of openings;
an array of dispensing stations, each dispensing station corresponding to one of the array of openings and including:
at least one dispensing surface extending from the substrate panel, the at least one dispensing surface including a continuous circumferential surface with an opening disposed therein.

17. The device of claim 16, wherein the at least one dispensing surface is conical and the opening is disposed at an apex of the at least one dispensing surface.

18. (canceled)

19. (canceled)

20. The device of claim 19, wherein the at least one dispensing surface defines a substantially conical frustum and includes a spout located at a perimeter of a conical frustum apex, and wherein the opening is located at a spout apex.

21. The device of claim 16, wherein the substrate panel is configured to overlay the multi-well plate with the array of dispensing stations extending into respective wells of the multi-well plate.

22-30. (canceled)

31. A method of dispensing liquid to a multi-well plate via a pipette, the method comprising:
dispensing predetermined amounts of liquids onto each dispensing surface of an array of dispensing stations of a multi-well plate overlay device, each dispensing surface being arranged at a substantially non-parallel angle with respect to a bottom surface of the multi-well plate overlay device; and
causing distribution of the predetermined amounts of liquids from each dispensing surface to respective wells of the multi-well plate.

32-34. (canceled)

35. A device configured to overlay a multi-well plate, the device comprising:
a substrate panel having a top surface and a bottom surface and including an array of openings; and
an array of dispensing stations, each dispensing station corresponding to one of the array of openings and including: at least one wall extending from the substrate panel and configured to overlay well walls of the multi-well plate to a predetermined depth, the at least one wall defining a circumferential surface with a pipette opening disposed therein.

36. The device of claim 35, wherein the at least one wall defines a partially circumferential surface with a pipette opening disposed therein.

37. The device of claim 35, wherein the at least one wall defines a continuously circumferential surface with a pipette opening disposed therein.

38. The device of claim 35, wherein the array of openings and the array of dispensing stations are configured to correspond to at least a portion of an array of wells in the multi-well plate.

39. The device of claim 38, wherein the pipette opening is configured to admit a pipette tip and maintain the pipette tip a defined distance from a bottom of a corresponding well of the multi-well plate.

40. The device of claim 38, wherein the pipette opening and a respective opening of the array of dispensing stations are not co-axial with a corresponding well of the multi-well plate and the pipette opening is configured to direct a flow of liquid from a pipette tip to a side of a bottom of the corresponding well of the multi-well plate.

41. The device of claim 38, wherein the pipette opening is configured to admit a pipette tip and maintain the pipette tip a defined distance from a side wall of a corresponding well of the multi-well plate and wherein the at least one wall has an axis that is substantially non-perpendicular to a bottom of the corresponding well of the multi-well plate and is configured to direct a liquid flow from the pipette tip to the side wall of the corresponding well.

42. The method of claim 31, further comprising
applying mechanical force to the multi-well plate;
wherein distribution of the predetermined amounts of liquids is caused in response to the mechanical force.

43. The method of claim 31, further comprising
applying pressure to the multi-well plate via a pressure manifold;
wherein distribution of the predetermined amounts of liquids is caused in response to the pressure.
